(19) United States
(12) Patent Application Publication
(10) Pub. No.: US 2022/0188857 A1
(43) Pub. Date: Jun. 16, 2022

(54) Coupon System for Goods and Services

(71) Applicant: Luke J. Niemela, Taylors, SC (US)

(72) Inventor: Luke J. Niemela, Taylors, SC (US)

(21) Appl. No.: 17/684,216

(22) Filed: Mar. 1, 2022

Related U.S. Application Data
(63) Continuation-in-part of application No. 16/795,877, filed on Feb. 20, 2020, now abandoned.
Application No. 16/795,877 is a division of application No. 15/218,568, filed on Jul. 25, 2016, now abandoned.
(60) Provisional application No. 62/196,105, filed on Jul. 23, 2015.

(51) Int. Cl. G06Q 30/02

(52) U.S. Cl. CPC G06Q 30/0225; G06Q 30/0235

(57) ABSTRACT

A system and method for generating and implementing a promotional offer for goods and/or services, including collaborating with at least one of a retailer, manufacturer and consumer to determine at least one parameter pertaining to creation, alteration, distribution, redemption, and/or payment terms of the promotional offer, implementing the parameter, creating and implementing the promotional offer, monitoring the implementation of the promotional offer, and determining whether the one promotional offer complies with the parameter constituents.

### RELATED APPLICATION DATA

This application is a continuation-in-part application to, and claims priority to, U.S. patent application Ser. No. 16/795,877, filed Feb. 20, 2020, which claims priority under 35 U.S.C. § 119(e) from United States Provisional Patent Application Ser. No. 62/196,105, filed Jul. 23, 2015, and which is a divisional from U.S. Nonprovisional patent application Ser. No. 15/218,568, filed Jul. 25, 2016, the entirety of all of which are being hereby incorporated by reference.

### TECHNOLOGICAL FIELD

The present invention relates generally to systems and methods of selectively collaborating, customizing, and validating manufacturer's and store coupons for purchases of goods and/or services by consumers.

### BACKGROUND

Certain manufacturers of consumer products, mostly in the food industry, distribute coupons to consumers through various media channels on a regular basis. For example, Sunday newspaper inserts have typically featured food manufacturer's coupons for readers to browse, select, clip, and use (redeem at participating stores). Furthermore, in recent years, the use of the internet and websites have made similar manufacturer's and/or store coupons available in an electronic (digital) format of which a consumer can browse, select, print, and use to save on certain consumer products. In either case, each coupon contains certain elements in which the manufacturer leverages, in various combinations and/or configurations, to receive the desired outcome based on its objectives for each promotion. Those elements typically include: product description, the product purchase quantity requirement (the number of products required to be purchased at the time of presenting the coupon), the dollar value of the discount amount (face value of the coupon) realized when the purchase requirement is met (the amount of price reduction taken from the price of the product(s) during the transaction), and the amount of time allowed to use/redeem the coupon (the expiration date). These variable elements are typically preset by the manufacturer and/or in combinations that are projected to yield the most efficient results. By reviewing historical data, manufacturers have learned which combinations of these variables potentially yield those desired results. The learning may be similar to examples such as, but not limited to:
1. the lower and less restrictive the purchase requirement, the higher the likelihood of a consumer redeeming;
11. the higher the discount amount/face value, the higher the likelihood of a consumer redeeming;
111. the longer the time period for use prior to the expiration date, the higher the likelihood of a consumer redeeming; and/or
IV. the greater the number of retailers at which the consumer can redeem the coupon, the higher the likelihood of a consumer redeeming.

The aforementioned examples illustrate the variable elements and the results typically associated with such changes. These elements are preset by the manufacturer and then presented as such to the consumer. In some offerings, manufacturers may present the same coupon to all consumers in all available markets in mass quantities distributed through newspapers. In other offerings, certain manufacturers may use an approach that offers some variation of the coupon targeted to certain consumer segments based on the analysis derived from data which could include market data, demographics, psychographics, location, past purchase behavior, and/or other customer-specific data which may be available to the manufacturer.

Manufacturers and retailers may find the distribution, acceptance, and processing of paper coupons cumbersome, expensive, and/or time-consuming. Consumers may also share in such findings while adding environmental concerns about the paper usage, manufacturing, and/or transportation of such paper coupons. Such coupons offered to the market are preset and may or may not be the most competitive offering in the marketplace at the time. While one of these examples may improve upon the other, they both may have short-comings and/or deficiencies that limit promotion and/or marketing effectiveness.

Therefore, it may be desirable to have systems and methods that take into account at least some of the shortcomings and/or deficiencies, as well as possibly other issues.

### BRIEF SUMMARY

Generally, the present disclosure relates generally to systems and methods for allowing an end user (such as a consumer) to progress through a series of prompts, pages, questions, and/or forms, indicating preferences pertaining to the purchase of certain consumer products and/or services wherein the user customizes coupon offer(s) within given parameters and receives coupon(s) that more closely match the consumers desires at that time; and in particular systems and methods that allows collaboration between the consumer, manufacturer, and retailer of goods/services in a dynamic and virtually real-time basis that may provide benefits to all users and increase the promotional effectiveness. Consumers may indicate preferences that include the planned purchase quantities of certain products and the desired purchase location, in exchange for potentially increasing the available discounted amount for the product(s).

The systems and methods discussed herein provide consumers with the ability to increase/decrease the face value (amount of discount) of a manufacturer's or store coupon for products (which may include grocery items and/or other bar-coded consumer packaged goods) based upon indicating preferences and purchase commitments, including changes in purchase requirements, usage timelines (expiration dates), using within certain retailer channels, completing reviews, surveys, using similar manufacturer's coupons previously, promoting product offer(s), and/or by completing other required tasks as requested, and thus utilizing the offer created and in turn increasing the sales of products for the manufacturer and increasing the discount amount for the end user.

The systems and methods discussed herein allow manufacturers to enter offer parameters (rule sets) into a database and such information is retrieved and/or referenced when consumer(s) request offers and indicate preferences. These parameters allow the systems and methods to return values within the parameters that match or closely match the requests of the consumer.

The systems and methods of the present disclosure allows for retailers to enter offer parameters of their own that may add to or enhance a manufacturer's coupon (offer) with additional value in an effort to entice the consumer to redeem such offer at its locations. In such a case, the systems and methods may dynamically change the offer from a “Manufacturer's Coupon” to a “Store Coupon” which may provide additional value to the parties. The systems and methods disclosed herein provide the ability for manufacturers and retailers to enter value parameters (as in minimums and maximums) that can be used to place bids in set increments that combine to create coupons (offers) that may be more competitive than other coupons in the market at the current time. The systems and methods disclosed herein also provide the ability to track, validate, and redeem (use) coupons at participating retailers' point-of-sale systems through independent validation matched with the retailers' systems that may provide the level of substantiation manufacturers require to remit payment to retailers without the need to further process paper coupons.

More specifically, the systems and methods of the present disclosure provide manufacturers, retailers, and/or consumers the ability to enter parameters specific to each of the variable elements presented on a coupon, of which the systems and methods will reference when a consumer (or other user) makes a request for a coupon. When custom requests are initiated by the consumer, the Systems are configured to return a coupon with the variable elements combined as requested and/or within the set parameters and are configured to be ready for the consumer to accept and subsequently use. Manufacturers may find that having the ability to create rules around the dynamic creation of coupons based on market conditions, competitive offerings, consumer demands, inventory levels, and/or product dating produce more efficient promotional channels.

According to an aspect of the present disclosure, a system for generating and implementing one or more promotional offers for goods and/or services is provided. The system includes a communications interface configured to enable retailers, manufacturers, and consumers to collaborate, via a wired or wireless network, to determine one or more parameters pertaining to each of one or more promotional offers. The system includes one or more computing nodes in electronic communication with one or more point-of-sale devices. Each edge node includes a processor and a computer-readable storage medium comprising one or more programming instructions. The programming instructions, when executed, cause the processor to generate a unique master coupon code, wherein the unique master coupon code is linked to the one or more promotional offers, and read the unique master coupon code at a first location, generating a list of the one or more promotional offers linked to the unique master coupon code. Reading the unique master coupon code includes validating the unique master coupon code by cross-referencing, via the communications interface, the unique master coupon code with one or more coupon codes stored at a second location, and sending an indication of validity to the first location. The programming instructions are further configured, when executed, to cause the processor to determine, for each of the one or more promotional offers, whether the one or more parameters have been met, and redeem each promotional offer for which the one or more parameters have been met.

The system may include at least one point-of-sale device. The system may also include a plurality of point-of-sale devices. Each point-of-sale device in the plurality of point-of-sale devices is in electronic communication with a unique computing node of the one or more computing nodes, and results in a corresponding decrease in the computing power needed for each processor of the one or more computing nodes added to execute the one or more programming instructions.

According to various embodiments, the one or more computing nodes are configured such that an increase in a number of computing nodes decreases an overall timeframe needed to execute the one or more programming instructions.

According to various embodiments, the one or more parameters include one or more of the following: creation of the one or more promotional offers; alteration of the one or more promotional offers; distribution of the one or more promotional offers; redemption of the one or more promotional offers; and payment terms for the one or more promotional offers.

The potential benefits of such systems and methods for the manufacturer includes the ability to deliver custom coupons to individual consumers in an environment that meets (or is as close as possible to) the current needs of the consumer and thus may increase the number of consumers using the customized coupons, thereby increasing the effectiveness of the promotion. For the retailer, the systems and methods disclosed herein may provide the benefit of adding the retailer's own value to existing Manufacturer's Coupons to entice the consumer to use at its locations. For the consumer, the systems and methods may provide a benefit of producing coupons/offers that more closely match his or her desires and purchase plans and therefore maximize the total value received. The systems and methods thus provide a dynamic collaboration between the manufacturer, retailer, and consumer that may result in a more closely-matched promotional vehicle resulting in a more efficient promotional channel.

The systems and methods disclosed herein may provide several other element(s) offered in certain combinations to the consumer, such as, but not limited to: a coupon in which the consumer may select particular product(s), sizes of product(s), and/or any combination of products, brands, retailers, and/or manufacturers as variable elements leveraged and combined to achieve the desired value and/or discounted amount.

### BRIEF DESCRIPTION OF THE DRAWING

Having thus described example implementations of the disclosure in general terms, reference will now be made to the accompanying drawings, which are not necessarily drawn to scale, and wherein:

FIG. 1 is a schematic view of a Manufacturer's Coupon base offer reflecting a method of creating user-defined and customized coupons, and shows one or more of the variables in which may be customized by the user according to one or more example implementations of the present disclosure;

FIG. 2 is a schematic view of a Store Coupon base offer reflecting a method of creating user-defined and customized coupons, and shows one or more of the variables in which may be customized by the user according to one or more example implementations of the present disclosure;

FIGS. 3A-3C are schematic views of a custom created and user-defined coupon starting from a base offer of a method of creating user-defined and customized coupons, and shows the process by which the consumer may progress through a series of prompts and create a customized coupon according to one or more example implementations of the present disclosure;

FIG. 4 is a schematic view of a custom created and user-defined coupon starting from scratch (not from a base offer) of a method of creating user-defined and customized coupons, and shows the process by which the consumer may enter the desired elements of a coupon directly into a form and create a customized coupon according to one or more example implementations of the present disclosure;

FIG. 5 is a schematic view of a consumer profile reflecting a method of collecting and displaying information pertaining to consumers using the systems and methods according to one or more example implementations of the present disclosure;

FIG. 6 is a schematic view of a manufacturer's database representations of types of data entered, collected, and/or stored for use and/or referencing by the systems and methods according to one or more example implementations of the present disclosure;

FIG. 7 is a schematic view of a retailer's database representations of types of data entered, collected, and/or stored for use and/or referencing by the systems and methods according to one or more example implementations of the present disclosure;

FIG. 8 is a schematic view of a consumer database representations of types of data entered, collected, and/or stored for use and/or referencing by the systems and methods according to one or more example implementations of the present disclosure;

FIG. 9 is a schematic view of a coupon redemption and validation process at a retailer's location through its point-of-sale system connected to the systems and methods according to one or more example implementations of the present disclosure;

FIG. 10 is a schematic view of a personalized coupon representation showing an example of such personalization according to one or more example implementations of the present disclosure;

FIG. 11 is a schematic view of a final price coupon representation showing an example of a final price scenario according to one or more example implementations of the present disclosure;

FIGS. 12A-12D are schematic views of a manufacturer presenting progressive coupons to a consumer based on redemption information and validation according to one or more example implementations of the present disclosure;

FIG. 13 is a schematic view of coupons triggered by events based on parameters set in the systems and methods according to one or more example implementations of the present disclosure;

FIG. 14 is a schematic view of displaying coupon quantity limits pertaining to a particular offer according to one or more example implementations of the present disclosure;

FIG. 15 is a schematic view of a Manufacturer's Coupon changing to a Store Coupon upon the consumer selecting a specific retailer for redemption according to one or more example implementations of the present disclosure;

FIG. 16 is a schematic view of a Store Coupon with various expiration and/or use limitations according to one or more example implementations of the present disclosure; and

FIG. 17 illustrates an apparatus that according to some example implementations may be configured to at least partially implement a computer, or, controller system in accordance with example implementations.

FIG. 18 is a schematic view of an edge computing system in accordance with example implementations of the present disclosure.

Each figure shown in this disclosure shows a variation of the embodiments presented, and only differences will be discussed in detail.

### DETAILED DESCRIPTION

Some implementations of the present disclosure will now be described more fully hereinafter with reference to the accompanying drawings, in which some, but not all implementations of the disclosure are shown. Indeed, various implementations of the disclosure may be embodied in many different forms and should not be construed as limited to the implementations set forth herein; rather, these example implementations are provided so that this disclosure will be thorough and complete, and will fully convey the scope of the disclosure to those skilled in the art. Also, something may be shown or described as being to a first, second, third or the like should not be taken to imply a specific order, unless otherwise stated. Further, although reference may be made herein to a number of measures, predetermined thresholds and the like such as dollar amounts, units, percentages and the like, according to which aspects of example implementations may operate; unless stated otherwise, any or all of the measures/predetermined thresholds may be configurable. Like reference numerals refer to like elements throughout.

Example implementations of the present disclosure are generally directed to systems and methods of creating and customizing Manufacturer's Coupons of consumer goods and/or services in an interactive, dynamic, and/or collaborative manner by the consumer, the manufacturer, and/or retailer. Example implementations will be primarily described in the context of a retail store and a web-site provided by internet. It should be understood, however, that example implementations may be equally applicable to any of a number of other stores, supply chains, channels of trade, inter-business and intra-business (business to business (B-to-B)) scenarios and the like.

Example implementations of the present disclosure, systems and methods are provided for creating Manufacturer's and Store Coupons/offers and may include use of discounts and offers by consumers. It is to be understood that as used herein, “consumer” could include any recipient of a good and/or service, including without limitation, a retail recipient and/or purchaser, a wholesale recipient and/or purchaser, a B-to-B recipient and/or purchaser, government employee and/or agent or contractor recipient and/or purchaser, and the like. It is to be understood that as used herein, “manufacturer” could include any person or entity that either owns, produces, distributes, manages, sells, and/or otherwise has the authority to create and/or offer coupons/discounts to the market. It is to be understood that as used herein, “retailer” could include any person or entity that either sells, distributes, manages, and/or otherwise has the authority to create and/or offer coupons/discounts to the market.

Example implementations of the present disclosure, systems and methods are provided for creating Manufacturer's and Store Coupons/offers and may include use of discounts and coupon offers by consumers. It is to be understood that as used herein, “coupon(s)”, “offer(s)”, “discount(s)” may have been used interchangeable and could include any presentation of an offer from one party to another party in many formats, either printed, or electronically, including, but not limited to: a coupon, a voucher, a picture with or without caption(s), a bar-code, an offer code, and the like.

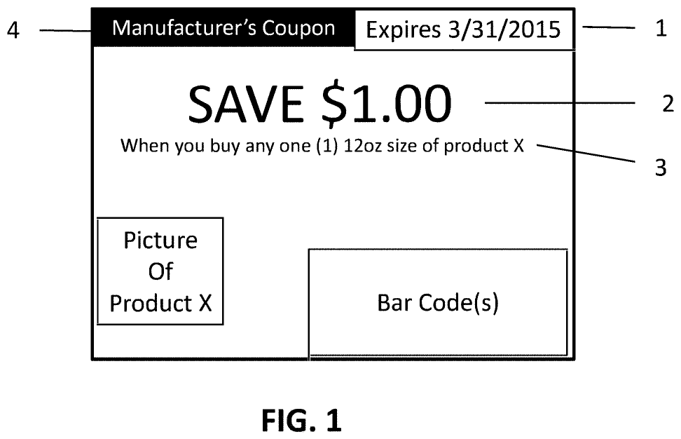

In FIG. 1, an example implementation of the present disclosure is depicted as a schematic of a Manufacturer's Coupon. In this implementation, at (1), the coupon expiration date is shown. At (2), the discount amount offered is shown. At (3), the purchase requirement(s) are shown. At (4), a heading of “Manufacturer's Coupon” is shown to indicate to the consumer that the coupon can be redeemed at retailers which accept Manufacturer's Coupons.

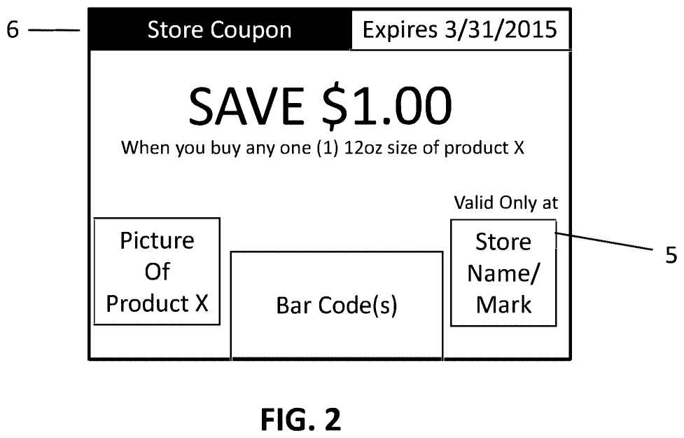

In FIG. 2, an example implementation of the present disclosure is depicted as a schematic of a Store Coupon. In this implementation, at (5), the Store Name and/or mark is shown to indicate at which specific Store the coupon can be redeemed. At (6), a heading of “Store Coupon” is shown to indicate to the consumer that the coupon can be redeemed only at the specific Store affixed on the coupon.

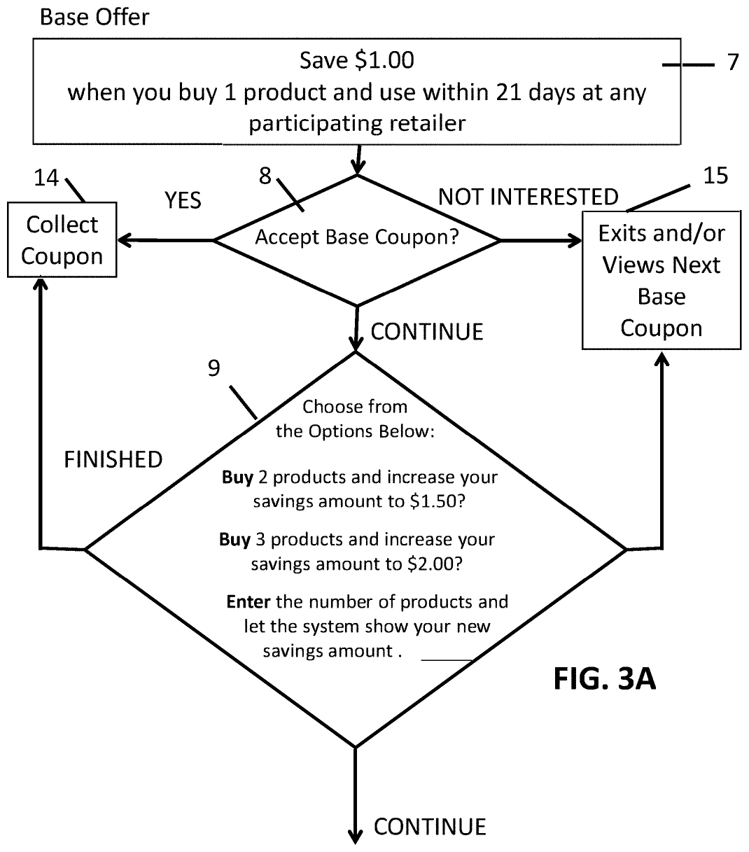

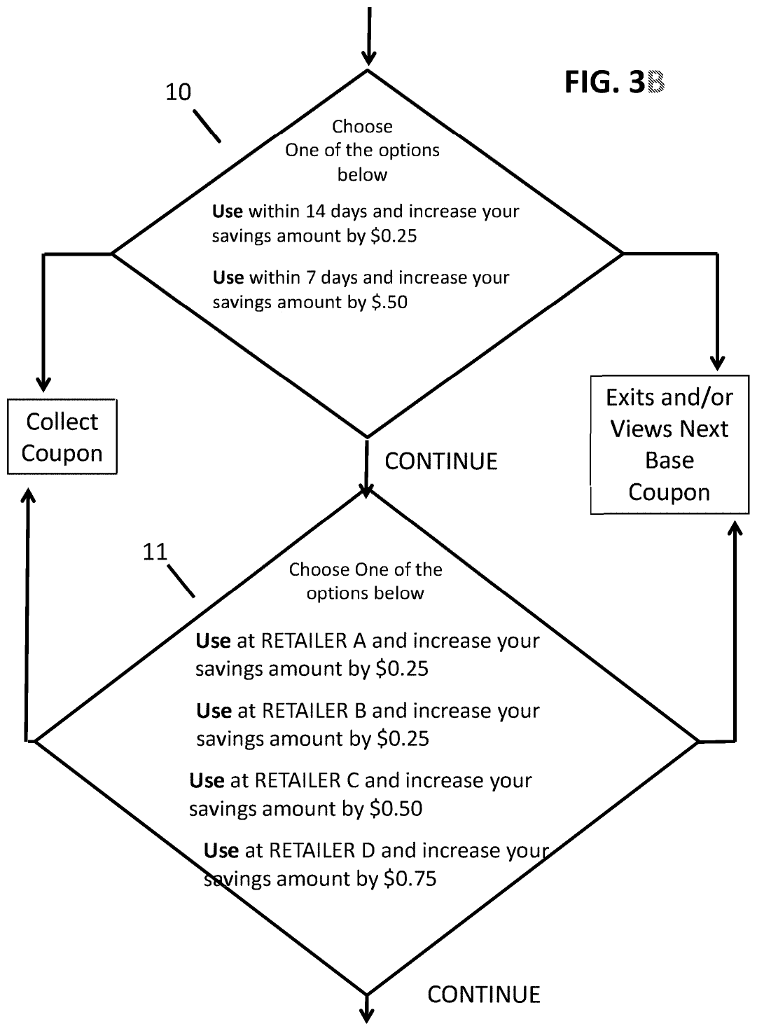

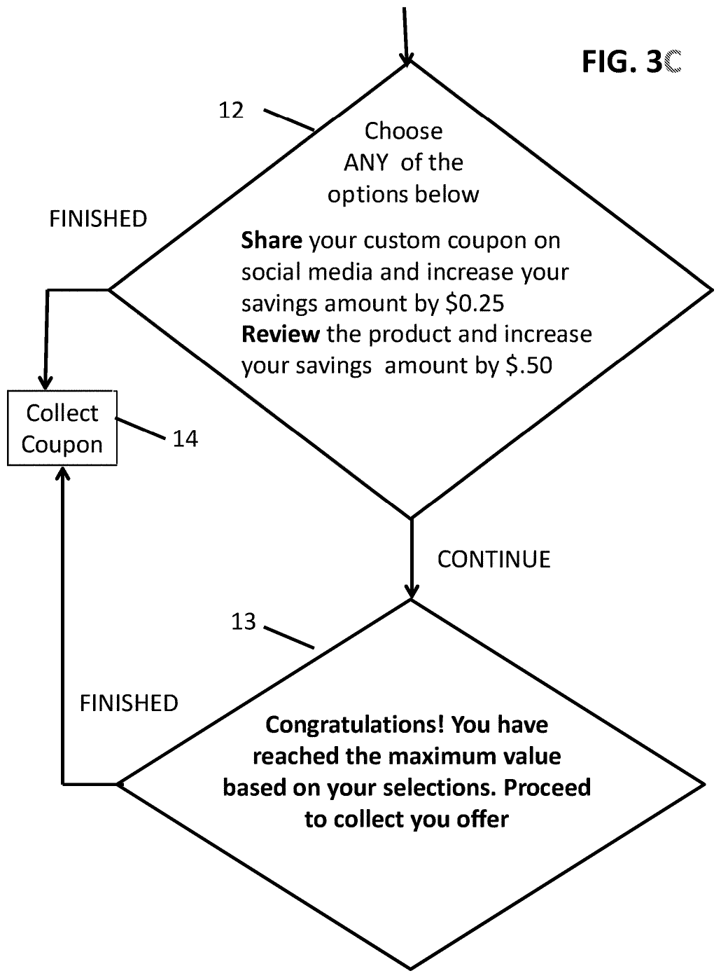

In FIGS. 3A-3C, an example implementation of the present disclosure is depicted as a flow chart of a method in which the consumer may custom create a coupon starting from a base offer. At (7), a manufacturer/retailer displays a base offer for the consumer to consider. At (8), the consumer is asked if he or she accepts the base coupon offer. At (9), the consumer has indicated that he or she would like further customization of the offer and chooses from those options presented. Those options include increasing the discounted amount by selecting an increase in product purchase requirements. At (10), the consumer is asked to choose from the options presented and increase the coupon savings offered by decreasing the time allowed for redemption. At (11), the consumer is asked to choose a retailer at which he or she will redeem the coupon with an offer of increasing the coupon face value by various amounts offered by specific retailer(s) as a means to entice the consumer. At (12), the consumer is presented with options of promoting his or her custom-created coupon on social media for additional savings, and/or giving a product review in exchange for increasing the face value of the coupon. At (13), the consumer is presented with a display that indicates that he or she has reached the maximum value and/or other limits for further customization of the offer. At (14), the consumer collects the coupon. At (15), the consumer may exit at any point during the customization process as described above.

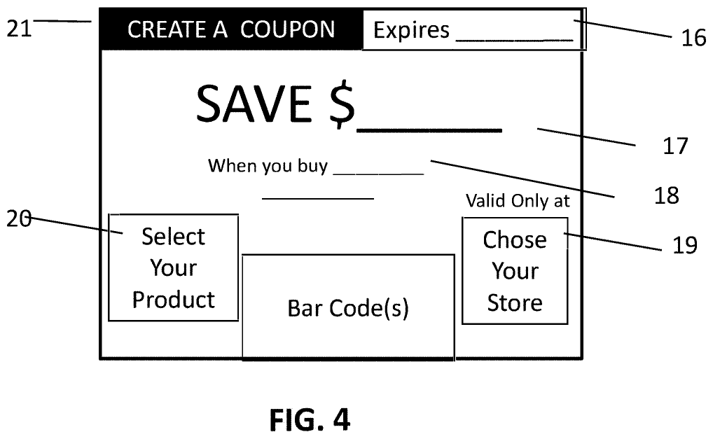

In FIG. 4, an example implementation of the present disclosure is depicted as a schematic of an example form wherein the consumer may enter desired elements to create a customized coupon. At (16), the consumer enters the desired expiration date. At (17), the consumer enters the desired face value of the coupon. At (18), the consumer enters the desired quantities of products(s) to be purchased in exchange for receiving the discounted amount. At (19), the consumer enters the desired store location at which the offer will be redeemed. At (20), the consumer selects the desired product(s) of which he or she will purchase in exchange for receiving the discounted amount. At (21), the coupon header will dynamically change from a Manufacturer's Coupon to a Store Coupon based on the previous selections made by the consumer.

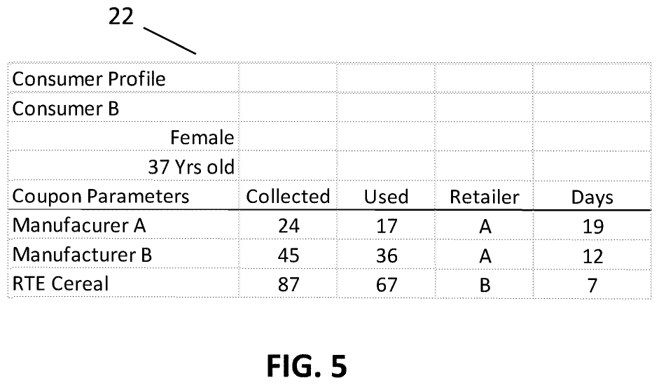

In FIG. 5, at (22), an example implementation of the present disclosure is depicted as a schematic of a Consumer Profile which displays certain information relating to a consumer that may be available to manufacturers/retailers through the systems and methods to provide data that may allow the manufacturer/retailer to customize and/or target future offers to the consumer. Such information includes coupons collected and/or redeemed, preferred products, categories, and/or retailers.

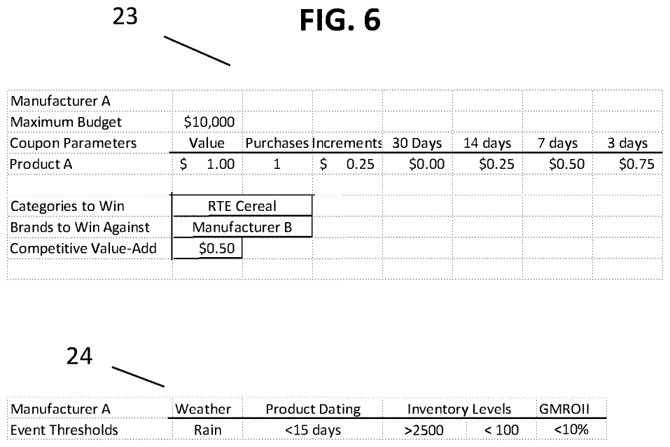

In FIG. 6, at (23), an example implementation of the present disclosure is depicted as a schematic of a Manufacturer Database wherein manufacturers may enter, collect, store, and/or share certain information and parameters pertaining to the display and customization of its offers. Manufacturers may enter budgetary amounts and desired increments for creating and/or bidding against other manufacturer's competitive offers. At (24), manufacturer may enter the parameters pertaining to events that trigger a promotion/coupon when such events occur and are outside of the set parameters.

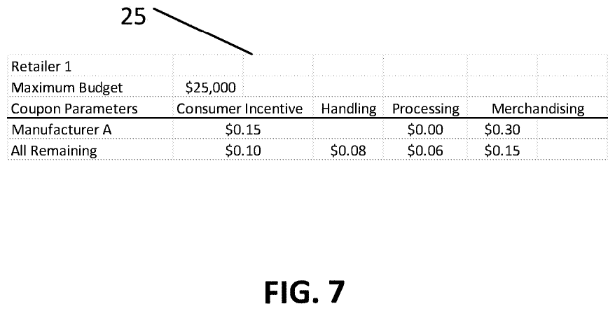

In FIG. 7, at (25), an example implementation of the present disclosure is depicted as a schematic of a Retailer Database wherein retailer may enter, collect, store, and/or share certain information and parameters pertaining to the display and customization of its offers. Retailers may enter budgetary amounts and desired increments for creating and/or bidding against other retailer's competitive offers. Retailers may also enter parameters pertaining to the customization of a Manufacturer's Coupon for certain manufacturers.

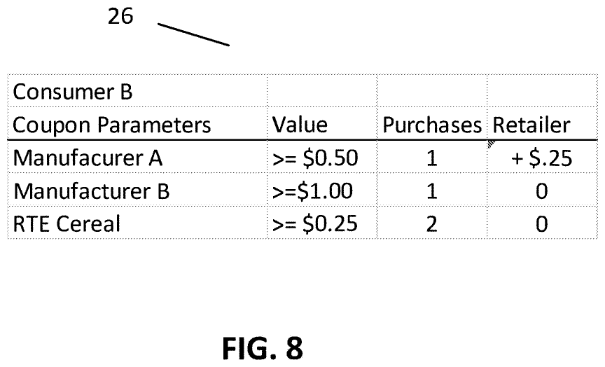

In FIG. 8, at (26), an example implementation of the present disclosure is depicted as a schematic of a Consumer Database wherein consumer may enter, collect, store, and/or share certain information and parameters pertaining to the display, presentation, and/or customization of offers which he or she would like to receive from manufacturers and/or retailers. When a consumer enters such information, the manufacturer and/or retailer may be given access to such as a means of sharing and collaborating on desired coupons. Using such information, manufacturers and/or retailers will have the ability to provide coupons that better match the consumer's desires. As such, consumers will also have the ability to expand or limit the presentation of offers by manufacturers and/or retailers that fall outside of his or her entered parameters.

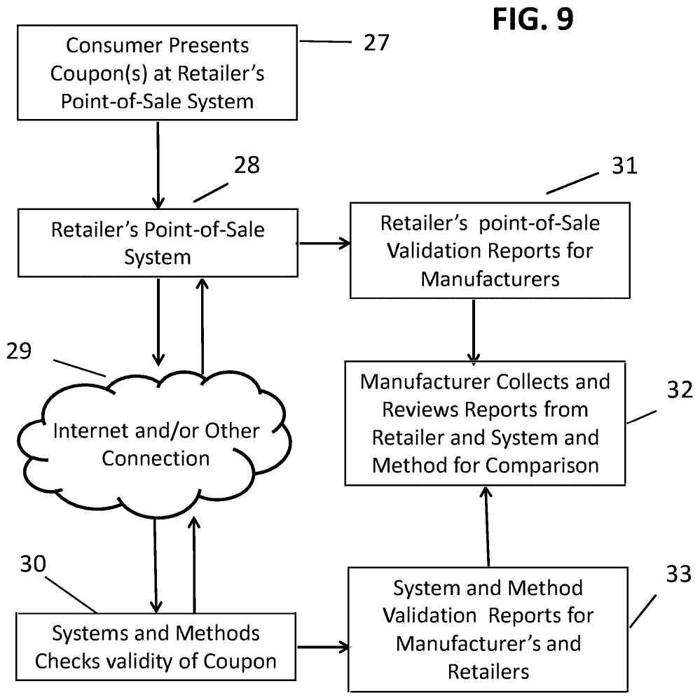

In FIG. 9, an example implementation of the present disclosure is depicted as a flow chart of the presentation, redemption, and validation of a customized coupon by the systems and methods. At (27), consumer presents customized coupon(s) for redemption at a retailer's point-of-sale system. At (28), the retailer's point-of-sale system connects through a communication interface (29) to the system for reference and validation of the coupon. At (30), the system references available data and returns to the retailer's point-of-sale system, a value indicating the validity of the coupon. At (31), the retailer's point-of-sale system creates reports totaling the redemption and/or validation of customized coupons available for review by the manufacturer and/or retailer. At (32), the manufacturer collects and reviews reports from the retailer(s) and compares it to reports provided by the system (33). Through this review process of two (2) independently created reports, the manufacturer may determine that such reports provide sufficient data to reimburse the retailer for redeeming coupons without the need for further processing of paper coupons.

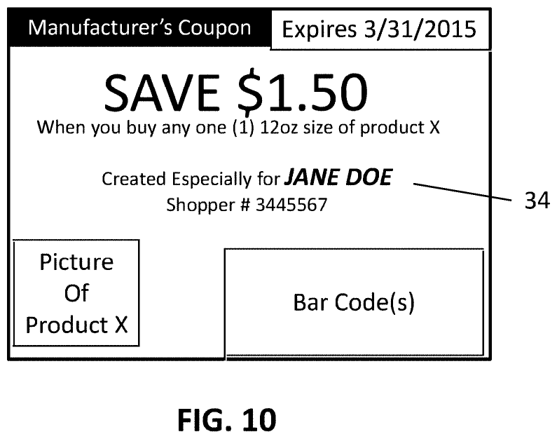

In FIG. 10, an example implementation of the present disclosure is depicted as a schematic of the personalization of a coupon wherein manufacturers and/or retailers may elect to add certain additional information of a personal nature to the face of a coupon. At (34), the consumer's name is added to the face of the coupon along with his or her shopper card number.

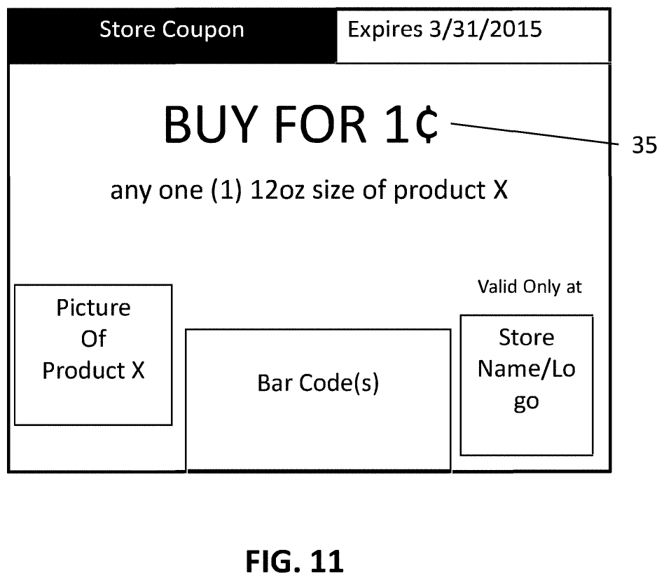

In FIG. 11, an example implementation of the present disclosure is depicted as a schematic of a Store Coupon stating a final price to be paid when purchasing stated product(s). At (35), the coupon displays a final price of 1¢ for any one (1) product purchased regardless of the retail price displayed at the location where the coupon is redeemed.

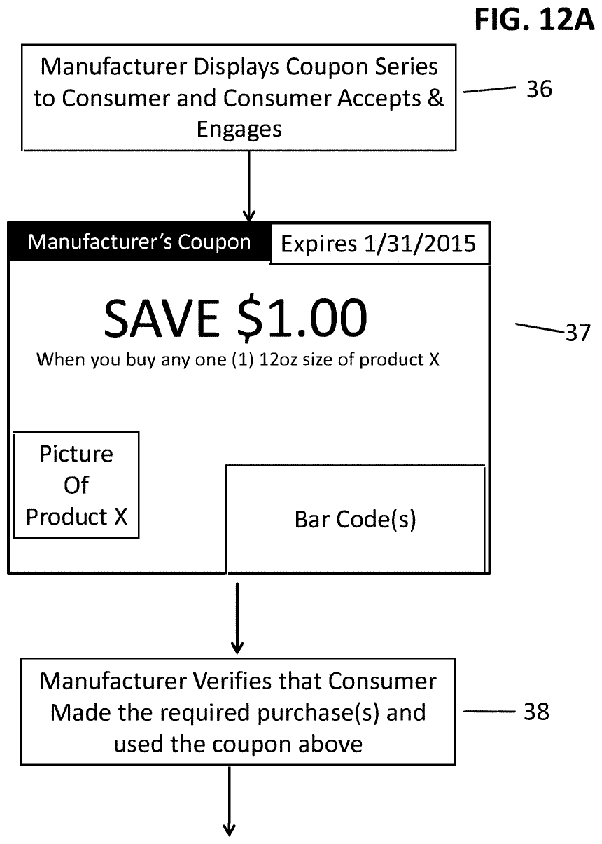

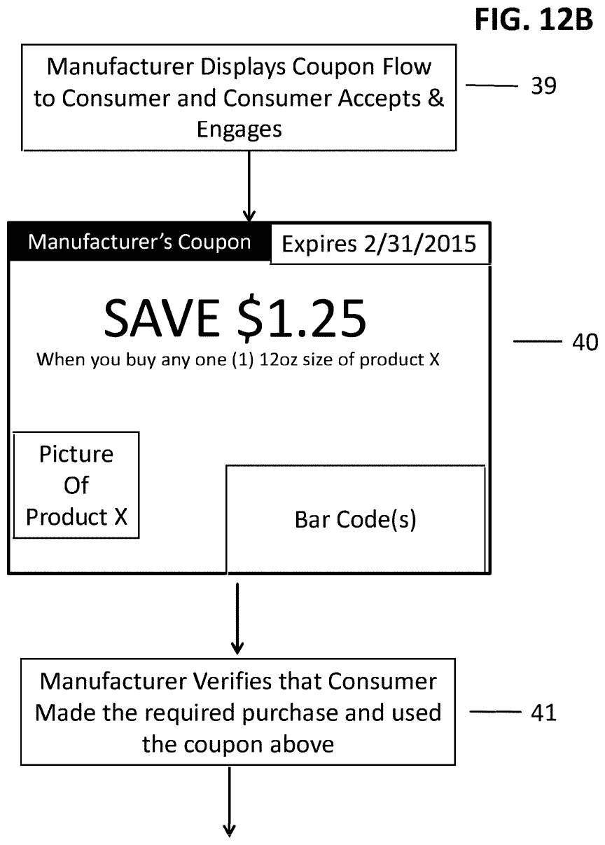

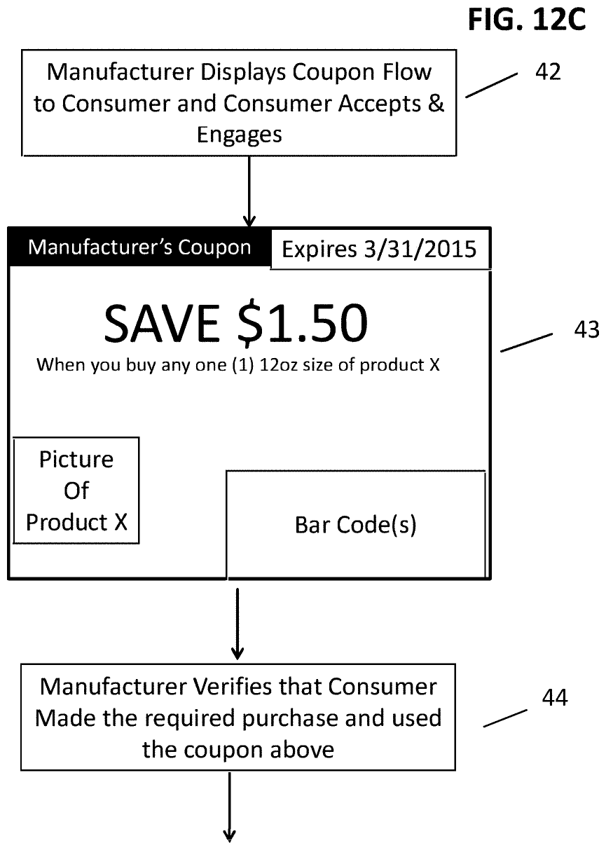

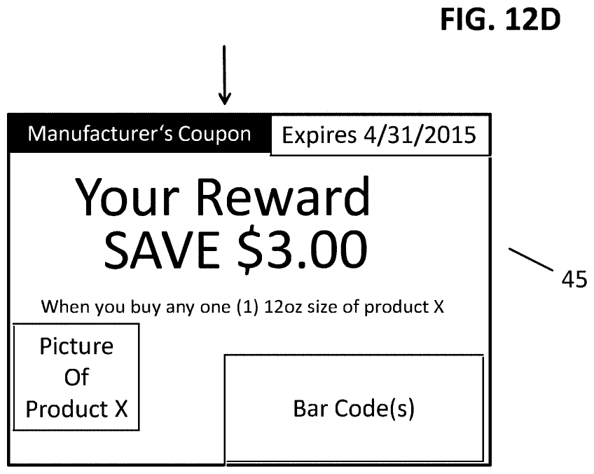

In FIGS. 12A-12D, an example implementation of the present disclosure is depicted as a flow chart of a process wherein a manufacturer makes future offers available to a consumer when he or she uses previous offers and the offers get progressively better over time and provide a high value reward coupon at the end of the progression. At (36), the manufacturer displays the series of coupons available and the consumer engages. At (37), the first coupon valued at $1 is displayed and offered to the consumer. At (38), the system provides validation to the manufacturer of the coupon and triggers the next coupon in the series to be presented. At (39), the consumer is presented the coupon series and continues to engage. At (40), the second coupon in the series is presented and is a progressively better offer, valued at $1.25. At (41), the system provides validation to the manufacturer of the coupon and triggers the next coupon in the series to be presented. At (42), the consumer is presented the coupon series and continues to engage. At (43), the third coupon in the series is presented and is a progressively better offer, valued at $1.50. At (44), the system provides validation to the manufacturer of the coupon and triggers the next coupon in the series to be presented. At (45), the consumer is presented the final reward coupon, representing an increased value. In this example, the manufacturer made commitments to present increasingly better discounts in progression, with a final high value reward at the end, in exchange for the consumer making the required purchases over time.

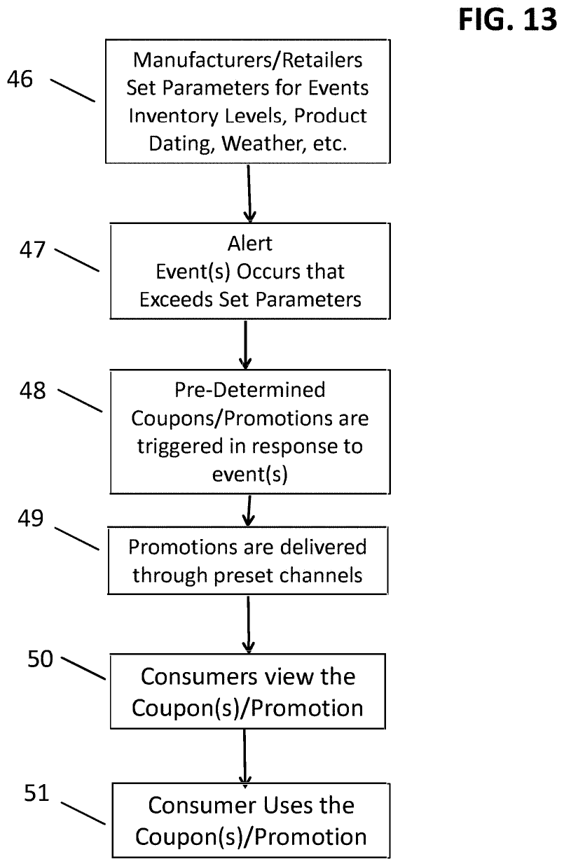

In FIG. 13, an example implementation of the present disclosure is depicted as a flow chart of a process wherein a manufacturer and/or retailer may set parameters relating to events that trigger the presentation/distribution of a coupon offer to the market. At (46), the manufacturer and/or retailer sets thresholds related to events such as inventory levels, product dating, weather, etc. At (47), the manufacturer and/or retailer is alerted of an event that falls outside set parameters and the system may trigger a coupon promotion. At (48), the system triggers the release of a predetermined coupon to the market based on such events. At (49), the coupon is sent to the predetermined distribution channel(s). At (50), the targeted audience views presented coupon offers and determines interest. At (51), interested consumers collect and use coupon(s).

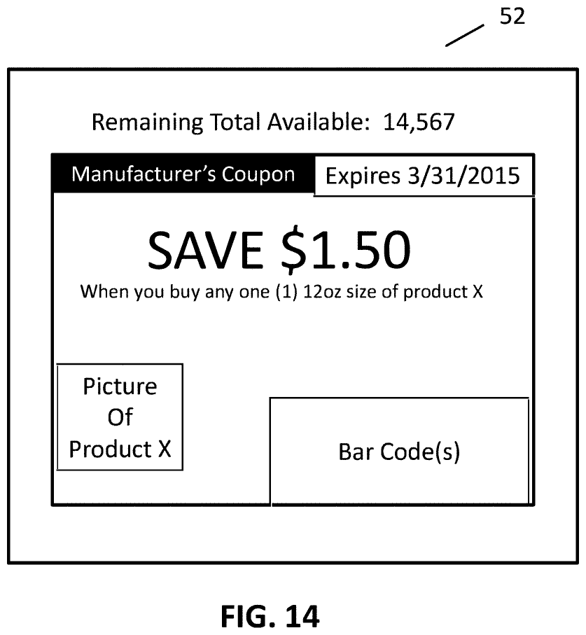

In FIG. 14, an example implementation of the present disclosure is depicted as a schematic representation of the displaying of quantity information pertaining to a specific offer. At (52), the current quantity available for collection/use is displayed for the consumer to view. As such, consumers may determine that such coupons are in limited supply and may prompt him or her to use and/or use in a quicker manner.

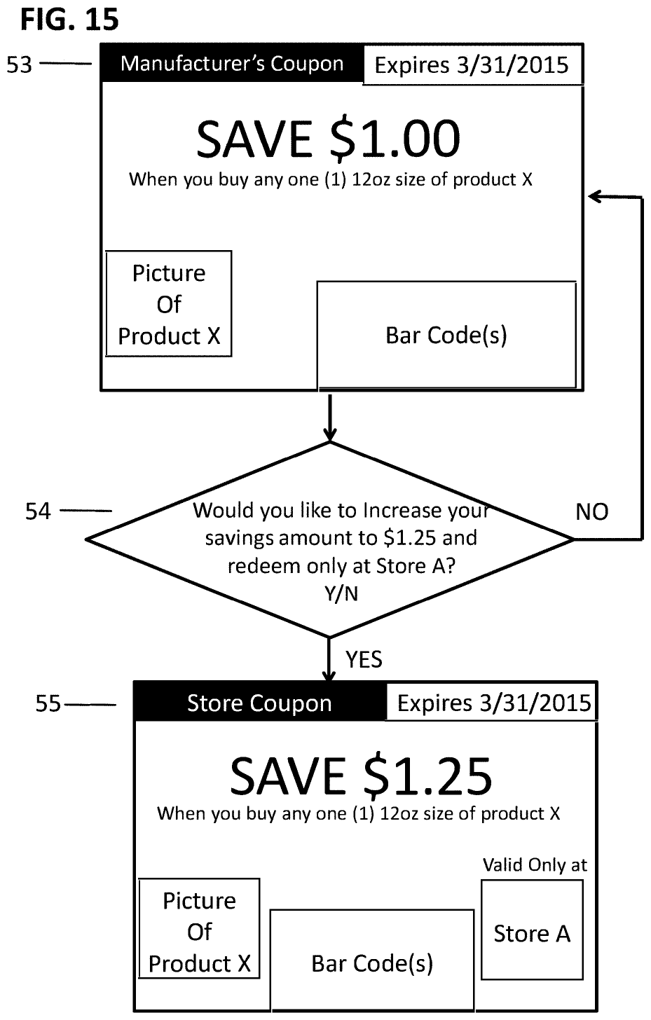

In FIG. 15, an example implementation of the present disclosure is depicted as a flow chart of a process of the systems change from a Manufacturer's Coupon offered by a Manufacturer to a Store Coupon when certain elements of such coupon are changed by another user, such as a consumer or retailer. At (53), the coupon offered starts as a Manufacturer's Coupon and can be redeemed at any retailer that accepts Manufacturer's Coupons. At (54), a consumer is prompted to select Store A for the exclusive redemption of the coupon in exchange for receiving an increase in the face value of the coupon. Such increase may be paid by Store A in an effort to entice the consumer to convert the coupon into a Store Coupon redeemable only at its locations. At (55), the consumer had selected “Yes” and the face value of the coupon changed from $1 to $1.25 and the coupon changed into a Store Coupon.

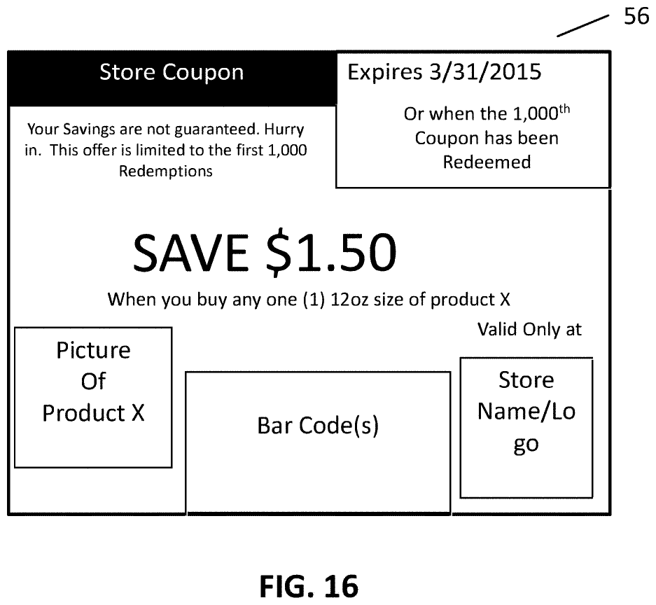

In FIG. 16, an example implementation of the present disclosure is depicted as a schematic representation of a Store Coupon with variable redemption/use limitations that may be determined by market conditions. At (56), the coupon states a final expiration date as well as a notice of potential expiration based upon the response by the market and as such, the coupon may become void when such events occur. The example includes a limitation to the validity of stated coupon based upon the total number of coupons redeemed in the market by other consumers. As such, the coupon validity is limited to, for example, the first 1,000 redemptions.

Referring now to the above-described Figures in even more detail, the systems and methods herein may provide both Manufacturer's Coupons (FIG. 1) and Store Coupons (FIG. 2), and each coupon may change between the two based on the consumers' preferences. For clarification, a header stating “Manufacturer's Coupon” (4) indicates that such coupon is valid at all retailers that accept Manufacturer's Coupons and therefore is not limited to a particular retailer, a header stating “Store Coupon” (6) indicates that such coupon is specific to one particular retailer and is usually accompanied by the retailer name and/or mark (5) affixed to the face of the coupon.

The following is a non-exhaustive list of examples of the subject matter according to the present disclosure.

According to one aspect of example implementations of the present disclosure, systems and methods are disclosed herein wherein a consumer may from time to time interact with the system to create customized Manufacturer's Coupons and/or Store Coupons as made available to him or her. A consumer may choose to redeem any number of these coupons at any given time within the time period allowed, insofar as the terms and conditions of each coupon are met. The coupons may be presented in paper and/or electronic form (depending upon requirements set forth by the manufacturer and/or retailer) at the time of purchase at the participating retailers' locations. When presented properly and in accordance with the terms and conditions of the offer, the consumer will immediately realize the discounted amount (face value of the coupon) during that transaction. For example, if the consumer presents the coupon stating a discount amount of $1.00 at the time of purchase and has complied with the purchase requirements as well as all other conditions, the consumer will immediately receive a $1.00 discount off that transaction. A consumer may present one or many the coupons during the transaction and realize the accumulated discount of presented and valid coupons.

According to other aspects of example implementations of the present disclosure, systems and methods are disclosed herein offering accessibility through multiple access points and may include, but not be limited to:
1. On a dedicated webpage accessible by internet through any connected device.
2. On a manufacturer's or retailer's webpage, including, but not limited to, owned, managed, and/or social sites. Potential benefits of this type of integration is that consumers are focused on the offerings of a single manufacturer's products and do not have the possibility of viewing other products which may be competitive in nature to the products.
3. Integrated into digital media advertising display campaigns whereby a consumer may see an advertisement for a particular product and then progress through the systems and methods to create and collect the customized coupon. Potential benefits of this type of integration include that the manufacturer may see an increase in activity performed by the consumer and thereby increasing the effectiveness of the advertising expenditure.
4. Integrated into manufacturer and/or retailer software application(s) located on or accessed remotely by electronic and/or mobile devices.
5. Integrated into third-party software applications located on or accessed remotely by electronic and/or mobile devices.
6. On a webpage/image accessible by mobile device through a search engine.

According to one aspect of example implementations of the present disclosure, systems and methods provide for allowing the consumer to pick and choose preferences from available options in the database of a computer memory system in a manner that increases and/or decreases, adds and/or subtracts variables as the consumer selects from options while interacting with such systems and methods. The consumer using the systems and methods has the ability, within the set parameters, to create and/or request coupon(s) that more closely match his or her needs and desires and planned future purchases. For example, while using the systems and methods, a consumer may select a Manufacturer's Coupon valid for a product that he or she may be interested in purchasing from those presented in an electronic form. The selected coupon may first display a base offer (FIG. 3A) that the consumer may choose to receive as-is, or he or she may elect to progress to another display (if available) to customize the coupon. In some cases, the “base offer” (7) may be the best and/or only offer available and the consumer may not customize it further. If such customization is available, then the consumer may progress (8). As such, in the next display, the consumer may select to increase the number of products (9) required to be purchased in exchange for a higher discount amount (face value of coupon); once satisfied with this selection, the consumer may proceed to the next display for further customizing. In the following display, the consumer may elect to shorten the time allowed to use the coupon in exchange for yet another increase in discount amount (face value of coupon) (10) (FIG. 3B); once satisfied with this selection, the consumer may progress to the next display. In the following display, the consumer may elect to choose a particular retailer for purchase of the product(s) and redemption of the coupon in exchange for another increase in the discount amount (face value) (11). The consumer may continue to progress through other options and displays (12) (FIG. 3C) until those options are exhausted (13) or the end user stops (15) at any time and collects the current coupon (or group of coupons, if participating in multiple product offerings) (14). In some cases, the manufacturer's base offer may be the best offer available to that consumer and/or the best offer available in the marketplace at that time, and therefore, no customizing options may be available such as those described above.

According to one aspect of example implementations of the present disclosure, systems and methods include the ability for the consumer to begin the coupon creation from scratch and without starting from a base offer (FIG. 4). As such, the consumer may create a coupon by entering the desired elements (16, 17, 18, 19, 20), and the systems and methods will cross-reference those with the available elements set in the systems and methods and will return those values that match or closely match the requests. The elements returned will complete a coupon and the consumer may collect and use. If the systems and methods are not able to produce a coupon with the requested elements according to the previously set parameters, then the systems and methods may produce a notification/report and send such to the manufacturer and/or retailer for review. A benefit may be that the consumer can start by entering his or her own desires into a form (21) and allow the systems and methods to search coupons/offers available that meet such desires and may return a coupon that is specific to the consumer in a manner that is more efficient. Another benefit may be that the manufacturer and/or retailer may find that such notifications detailing consumer requests for a coupon containing certain elements provide insights and information valuable for creating future promotions.

According to one aspect of example implementations of the present disclosure, systems and methods provide the consumer the ability to collect, store, and/or save coupon(s) in various ways, such as, but without limitation, by saving to the consumer's account in the systems and methods, by printing a paper copy, by loading an electronic copy to an electronic device, by producing an audible version, uploading to a retailer's shopper card account, a credit card or bank card account, or by receiving a website address link via email, text, or other electronic notification inside a particular application. The link(s) to the coupon(s) may include, but not be limited to, the image, the unique identifier, bar code, product information, purchase requirements, and other pertinent information, stored on a remote computer accessible by a plurality of devices, including but not limited to mobile phones, internet-connected mobile and non-mobile devices, laptop computers, point-of-sale systems, and other electronic systems and devices in which a consumer may use to access and retrieve content stored in remote locations.

Potential benefits of offering the systems and methods of a consumer collaboration and customized coupon may include the ability to increase promotional effectiveness of each offer for each particular consumer. During the interactive and collaborative process, the consumer is engaged in creating and/or customizing coupon(s)/offer(s) based upon his or her current needs and desires. With systems and methods that offer higher consumer engagement and involvement in the creation of a customized coupon, the likelihood of the consumer making the required purchases and redeeming the coupon may increase and thus increase the sales of products and the effectiveness of the promotion for the manufacturer/retailer.

Another potential benefit of a consumer creating and/or customizing his or her own coupon(s) is the ability for the product manufacturer to provide an offer that is customized to that particular customer, based on current situations and desires of the consumer. For example, the consumer may have the ability at the current time to make a purchase of multiple products and/or a larger quantity of products whereby in other methods the manufacturer would not have known this information and it may gain the advantage of an increased sales opportunity with the use of a coupon that requires a higher than normal purchase requirement.

Another potential benefit of offering systems and methods of a consumer customized coupon is to appeal to a consumer's current need for a specific number of products and reward the consumer with incremental savings on virtually as many products as desired, as long as the offer limitations and parameters are not exceeded. If for example, the consumer's desires exceeds the limitations of the available offers then the consumer may be presented with the offer that is as close as possible to the consumer's desires. In a scenario where the consumer's desires match the available offers and he or she receives such an offer, he or she may be less likely to find duplicate offers, collect other pre-printed coupons, and/or stack offers to reach his or her desired savings. In a case such as this, the systems and methods may reduce fraudulent use of Manufacturer/Store Coupons through photocopying of offers, executing multiple separate transactions, deal-stacking, and/or exceeding the per person redemption limit and/or violating other terms and conditions set forth on typical offers.

Another potential benefit of this systems and methods over pre-printed locally, regionally, and/or nationally distributed coupons could be that the individual consumer has input into the coupon offering that is acceptable to him or her. Typically, with preprinted coupons, the consumer can only choose from the coupon(s) received. There is also no interaction with the manufacturer, and the consumer's only decision is to accept offer(s) as-is or reject it. Additionally, the consumer may be able to work to get a better deal than what is presented in the mass market. The savings, purchase amounts, and expiration dates are of average amounts to appeal to a cross-section of the population in which typical redemption rates (usage rates) for programs like these have shown to be less than 1% according to industry reports, which could indicate that a better more interactive and collaborative system on a one-to-one basis is desired and may be more effective.

Another potential benefit of the systems and methods set forth herein over existing methods of using market-based data to target groups of consumers is that certain assumptions must be made as to the likelihood of a consumer group using a coupon based on available data. Offers must be created using a method that considers the response of the group as a whole and in many times the offer, as a result, may tend to be based on averages of the group and may not deliver the promotional effectiveness and/or results desired, which could indicate that a more interactive and collaborative system on a one-to-one basis is desired and may be more effective.

Another potential benefit of the systems and methods over existing methods of simply using behavior-based targeting (through the collection of prior purchase data) may be that these analyses consider historical data whereas the systems and methods may provide current data contributed by the consumer. This approach does not take into consideration the current needs or desires of each consumer and is usually based on assumptions as to how many products a consumer may buy and at what savings amount will trigger a response from the consumer. In these cases, consumers may be sub-segmented into groups with similar consumers and assumptions are made about potential usage rates of the coupon and the offers are created in an attempt to maximize the response rate of the group as a whole, which could indicate that a more interactive and collaborative system on a one-to-one basis is desired and may be more effective.

Another potential benefit the systems and methods herein may provide over current methods (wherein a consumer views a coupon on a website and selects it for use) is that those offerings are generic to all consumers and are not customizable by the consumer. Additionally, the manufacturer may not be effectively capitalizing on the future planned purchase of each specific consumer and providing an offer that fits the current needs of that customer. When an offer can be tailored by the consumer in a manner that reflects his or her desires and at the same time works within the parameters of the manufacturer's sales and budget goals, both parties can create an offer that could provide an increase in sales for the manufacturer and benefit the consumer with an offer that is relevant and is more likely to be used.

Another potential benefit of this systems and methods herein over current methods is that consumers who are interested in purchasing more than one product at any given time can indicate that preference and receive via notification (in electronic or paper form) when an offer that matches those purchase amounts is available. The savings amount may be increased from that of a more standardized (base) offer to entice and/or reward the consumer for making those purchases. Based upon predetermined savings amounts at various purchase requirements, expiration dates, and other variables, the system will reference the database of values and return the appropriate values for the consumer to view and accept.

Another potential benefit of the systems and methods is the ability for retailers to enter incentives designed to entice a particular manufacturer to create coupons/offers exclusively for its channel. For example, a retailer may offer, to one or many manufacturers, a reduction in coupon processing fees, handling fees, and/or offer other valuable incentives (like merchandising opportunities) to entice manufacturers to create offers specifically for their locations. In another example, the manufacturer may offer additional incentives to the retailer or to the retailer's customers to entice the retailer to accept its branded offers. This value exchange system allows both brands and retailers to collaborate and negotiate various offers and view competitive offers from other parties which may be interested in attracting the other. This provides an easy method for creating and accepting offers in a more timely fashion and changing offers, incentives, and other value exchanges as desired from time to time.

Another potential benefit of the systems and methods is the ability for retailers of the manufactured products to increase the savings amount of a Manufacturer's Coupon and entice the consumer to make the required purchases and redeem the offer at its locations and thus increasing its product sales. In current models some retailers may entice the consumer to redeem certain Manufacturer's Coupons at its locations by advertising the doubling the face value of the coupon up to certain limitations, which limits the ability to create an offer that is more dynamic and targeted to each customer while pooling these resources upfront as the consumer is receiving the coupon, versus after the fact when he or she is redeeming. The systems and methods herein may provide a much-improved process for enticing the consumer and retailer in a more efficient manner and may create an opportunity for certain retailers and manufacturers to pool resources and streamline the promotional channel, remove costs, and other barriers, to increase the effectiveness of each offer through a specific channel in an effort to increase promotional effectiveness.

According to other aspects of example implementations for the present disclosure, systems and methods allow the manufacturer and/or retailer to gain insight into the performance and activity of consumers who have created, collected, and/or redeemed its coupon(s) or similar coupons (FIG. 5). The system may also provide a ranking or totaling capability of each consumer and therefore allow the manufacturer to assess value to each consumer or each consumer group. Through these assessments, the manufacturer may decide to communicate additional offers or incentives to further entice the consumer to continue or increase future purchases of the manufacturer's product. An example (22) of this may include but not be limited to, “Consumer B,” who has shown a recent trend of redeeming multiple and various offers from a “Manufacturer A”, which may indicate an affinity towards “Manufacturer A,” and such an affinity could be considered valuable to the manufacturer such that the manufacturer may want to treat “Consumer B” differently than other consumers in an effort to cultivate and grow such affinity and further increase sales from “Consumer B”. In the preceding example, it should be understood that “Consumer B” could be a single consumer or a group of consumers acting in a similar fashion.

Manufacturer Database (Parameters & Rule Sets)

According to other aspects of example implementations of the present disclosure, systems and methods allow the manufacturer to access a database (FIG. 6) that allows it to enter values and other data necessary to set parameters, limits, and/or rules (23) around the customization of its offers by consumers and/or retailers. This database may hold, among other data, multiple table arrays in which values are entered, stored, and arranged in a manner that represents all available offer values and combinations of offer values. And, when queried by the system, the data returned populates its respective field and completes the coupon offer as requested by the consumer and/or within the parameters specified by the manufacturer (brand owner). In such, manufacturers and/or retailers can enter coupon/offer parameters, limits, ranges, and other pertinent information of which the offer system can access to populate coupon offers created by consumers in the system.

Retailer Database (Parameters & Rule Sets)

According to other aspects of example implementations of the present disclosure, systems and methods are provided in which allow a retailer which sells the manufacturers' products to consumers to access and populate a database (FIG. 7) with values and other data necessary to set parameters, limits, and rules (25) around the customization of its offers designed specifically for its retail locations. A retailer may also enter additional values, rules, conditions, enhancements, and/or enticements to certain Manufacturer's Coupons that may offer additional benefit to manufacturers and/or consumers when using (or allowing the use of) these offers in their locations. Such values or incentives may be selected and added to the coupons by the consumer and/or manufacturer to customize a coupon that is only good at its locations. In such a case the retailer may be adding its own funding to such coupons and may make such available funding known to the manufacturer and/or consumer in an effort to entice the manufacturer and/or consumer to offer or promote such to other users of the system. In addition to adding its own values to manufacturer's products and offers created in the system, the retailer may choose to promote its own products as a brand owner/manager and have access to its own manufacturer database for creating offers on its branded products.

Consumer Database (Parameters & Rule Sets)

According to other aspects of example implementations of the present disclosure, systems and methods are provided in which allow a consumer to access and populate a database (FIG. 8) with values and other data necessary to set parameters, limits, and rules (26) around the desired customization of offers presented to him or her. In doing so, the consumer is able to define and/or limit the coupons/offers that are presented to him or her in an effort to streamline the process and only consider offers meeting those rule sets. Such rule sets may include, but not be limited to, discount amount, product brand(s), sizes, purchase quantities, availability in the market, new product launches, locations, nutritional information, ingredients, packaging, and/or other desires based on the current needs of the consumer. A consumer may create notification thresholds whereby he or she is notified of an available coupon when an exact (or similar) product is available at a discounted amount.

Other Uses of the System Databases

According to other aspects of example implementations of the present disclosure, systems and methods include databases, which are centrally/remotely located and provide easy access for both the manufacturer and retailer. The systems and methods are designed to allow collaboration on coupons/offers available to consumers, retailers, and/or other manufacturers, in a manner that provides access/visibility into certain offers, and as such, a manufacturer and/or retailer may find it advantageous to work together and create more compelling and/or competitive offers in an effort to entice either a manufacturer or consumer. A potential benefit to the systems and methods may be that the manufacturer and retailer can come together, pool resources, and create coupons/offers that are variable yet designed within set parameters, and therefore may be more efficient and effective promotional spend.

Presenting Competitive (and other) Offers

According to other aspects of example implementations of the present disclosure, systems and methods include the ability for manufacturers to present offers to consumers that may compete with other customized offers presented to the consumer. For example, a consumer customizes a coupon from Manufacturer A, then Manufacturer B may have the desire to also present an offer for its product(s) that may be competitive (or complementary) in nature to the customized offer from Manufacturer A. In doing so, the consumer may have more and/or better choices of offers and creates an opportunity for competition between manufacturers for the consumer's business.

Key Performance Indicators, Historical Data, and/or User Information Database

According to other aspects of example implementations of the present disclosure, systems and methods allow the lookup and/or display of historical data on previous offers available to certain users, manufacturers, retailers, and/or consumers. This data may be, by way of example, but not to limit, displayed in charts, graphs, tables, and/or other arrays that may be viewed or collected for review or further analysis. Manufacturers and/or retailers may find it advantageous to review prior data collected through the system on its coupons/offers and consumer behavior and which offers performed better at what levels in an effort to create the appropriate offers on its products that may in turn increase the effectiveness of the promotion. Consumers using the systems and methods may provide certain information about themselves that includes, but is not limited to: name, address, email, phone, age, gender, income, product preferences, product purchases, usage information, household members, and/or other information as requested from time to time. This data may be made available to other users of the system as part of the user terms and conditions as set forth within the system. Furthermore, other data and/or performance indicators may be collected from third parties involved in the distribution, delivery, collection, redemption, storing, processing, and/or other functions involved in promotion and/or promotional channel.

Retailer Point-of-Sale Data and Coupon Usage Data

According to other aspects of example implementations of the present disclosure, the systems and methods herein provide a direct connection with the retailers' point-of-sale system (28) that allow for the exchange of information between the two (FIG. 9). In doing so, the systems and methods may include a piece of software or other integration and/or connections located near each retailers' point-of-sale system that allows the transmission of data in both directions (29). Transmitted data may include, but not be limited to: item purchases, pricing, transaction data, customer number, store loyalty number, date, time, location, coupon codes, and/or total purchase amount. With such connection available and data transmitted, the systems and methods (30) may validate the coupon codes by cross-referencing the coupon code(s) entered/scanned at the retail location with the coupon codes residing on the systems and methods, which may be located remotely, and return an indication of validity to the retailers' point-of-sale system. One potential benefit of such could be the ability to validate coupons during the transaction and in doing so, reduce fraudulent coupon usage. Another potential benefit of such systems and methods may be the ability to off-load some of the necessary computing power and/or software required at/in the point-of-sale system and may therefore reduce certain costs for the retailer and/or manufacturer (31, 32, 33). Another potential benefit of the systems and methods may be the ability to set coupon codes in the systems and methods without having to set such codes in each retailer's system. With coupon codes being validated through the systems and methods and its database of valid coupon codes, when a consumer presents a coupon, the coupon validation/redemption functions are no longer completely reliant and/or limited on/by the retailer and/or its systems.

Another potential benefit may be the ability to share such transactional and coupon usage data with the manufacturer to use accordingly to increase the promotional effectiveness of its campaigns. As such, manufacturers and/or retailers may offer additional value to consumers who utilize the electronic redemption process (versus the paper coupon alternative). Another potential benefit of the systems and methods may be the ability to share such data with the consumer, whereby he or she may store and/or utilize it to affect his or her usage of such coupons, make buying decisions, and/or plan shopping trips, etc.

Creation and Validation of Complex Offers

According to other aspects of example implementations of the present disclosure, systems and methods allows for the creation and validation of complex offers. Manufacturers may desire to create coupons that offer a discount/free item when certain products or combinations of products are purchased. A potential benefit may be the ability to create and validate more complex offers/coupons. Examples of this may be, but not limited to: buy ProdX and get ProdZ for free; buy 2 of ProdX and I of ProdY and get ProdZ for free; and/or buy I of ProdX and buy 3 of ProdY and save $3. In such examples, the discounted amount will reflect the actual retail price of the product “ProdZ” and/or within the set parameters, at the time of the transaction which may provide a more accurate method of reimbursing/settling with retailers.

Calculation and Accumulation of Units

According to other aspects of example implementations of the present disclosure, systems and methods provide the ability to calculate and accumulate units of measure across multiple transactions and/or multiple retailers within a consumers account. Manufacturers and/or retailers may find it beneficial to present, issue, and/or reward consumers with values that can accumulate over time when certain purchase requirements or actions have taken place. For example, manufacturers may offer a system of units (as in “points”, as an example) that accumulate when purchase requirements are met over time and those units/points may be redeemed at some point in the future for a predetermined value. A potential benefit may be the ability for the consumer to accumulate (earn) points across multiple independent manufacturers and across multiple independent retailers and exchange such for valuable offers presented from time to time. The systems and methods may provide advantages by performing the calculations, issuance, and maintenance of such units and therefore reducing the computing power and/or functionality of each retailer's point of sale system.

Unique Coupon Codes

According to other aspects of example implementations of the present disclosure, systems and methods provide the ability to create and affix unique coupon codes to each coupon generated within the systems and methods. Such codes may be randomly generated and unique to each coupon, unique to each consumer, and/or be uniquely generated through a combination of other data pertaining to the coupon. A potential benefit of generating unique codes may be the reduction in fraudulent use of coupons whereby a coupon is copied and presented by a consumer in an effort to gain an additional coupon. A potential similar benefit may also be extended to the retailer whereby the systems and methods could eliminate the duplicative scanning of a coupon. Another potential benefit may be the ability to better track the use of a coupon by a particular customer(s) by the manufacturer and/or retailer and therefore use such data to increase the promotional effectiveness of programs. Another potential benefit may be the ability to reduce some of the computing power, functionality, and/or costs necessary to scan and accept such coupons at the point of sale. Another potential benefit may be the ability to validate such coupon usage through the systems and methods in a manner which is acceptable to the manufacturer issuing the coupon. With such verification, the systems and methods may act, and be relied upon as, a third-party to the manufacturer and retailer, whereby the manufacturer may use the results outputted to compare against the retailer(s)' point-of-sale data to valid coupon usage prior to submitting payment (reimbursement) to the retailers. As such, the participating retailers may have similar access to such outputs/data for its use. Another potential benefit of such systems and methods may be that the manufacturer and retailer agree that a paper version of the coupon is not needed at the point-of-sale and that an electronic version may be acceptable and validated, and therefore the manufacturer will honor the retailer's request for payment and/or reimbursement of such without the need for a printed/paper version of the coupon to be further processed. Another potential benefit of the systems and methods herein may be the agreement between the manufacturer and retailer that allows the retailer to retain and/or destroy paper versions of presented coupons, and the parties shall rely on the outputs of the retailer's point-of-sale system and the output of the systems and methods as described herein. Such agreements between retailers and manufacturers may reduce the costs typically associated with the processing, handling, and/or transporting paper coupons and thus increase the promotional effectiveness. With the reduction of such costs, the retailers and manufacturers may use the systems and methods to collaborate, negotiate, and/or present offers to the other in an effort to entice the other to do business.

Geographically-Locating and the Use of Coupons

According to other aspects of example implementations of the present disclosure, systems and methods provide the ability to provide additional data during the coupon redemption and usage process through geographically-locating the consumer when a coupon is presented at a participating retailer. The systems and methods may record the location of consumer(s) when presenting coupon(s) as a means of providing an additional data point and verification that the redemption/use of the coupon(s) took place at a particular retailer's location. Through the cross-referencing of the consumer's location with the known locations of the participating retailers, the systems and methods may be able to further validate and/or defend the accuracy of its reporting. It may also provide additional security to prevent the unauthorized redemption/use of coupons. The systems and methods may record the location of a consumer when he or she interacts with the systems and methods from time to time and not just limited to the point in time when the coupon is presented for redemption/use. The potential benefit of such may be to provide more details to other users of the systems and methods and thereby increasing the reliability and accuracy of its data output.

Master Redemption Code for Multiple Individual Coupons

According to other aspects of example implementations of the present disclosure, systems and methods are provided where a unique master barcode may be created in the system when a consumer collects multiple individual Manufacturer's and/or Store Coupons to provide a quicker and easier redemption process. Such barcode is linked to those individual coupons and thereby represents and incorporates the necessary information and discounts of each. The master barcode is created in such a manner as to be recognized by the retailer's point-of-sale system and therefore can be received and/or scanned in electronic or paper form during the transaction, validated, and the appropriate discounts from all linked coupons will be provided to the consumer at that time. This may provide multiple benefits to the consumer and retailer, including but not limit to increasing the speed at which multiple offers can be redeemed during the transaction and provide faster and/or easier service for both parties. Another potential benefit may be the ability to reduce the number of printed coupons by printing one coupon versus multiple coupons and therefore reducing costs throughout the system.

User Account Profiles

According to other aspects of example implementations of the present disclosure, systems and methods are provided herein for a user (who may be a consumer or purchaser of certain consumer products, a retailer, and/or a manufacturer of consumer products) creates, manages, and periodically updates a profile.

An example consumer profile (22) may include, but not be limited to, age, income, name, address, product preferences, shopping behavior, prior purchases, future planned purchases, shopping lists, household information, links to his or her profile(s) on other sites (like social sites, networks, blogs, webpages, etc.) and other personal information. A consumer may also elect to create and/or sign-in using his or her existing profile/account from another qualifying website (as in social/networking site). Some or all of this information may be shared with other users, as desired. A consumer may view coupons that were created and shared by another consumer, and if he or she qualifies, may collect that offer as well.

An example manufacturer profile may include, but not be limited to, company information, links to other profiles/pages (like social sites, websites, blogs, networks, etc.), company history, listing of products, product details, supplemental product information, recipes, market availability, contact information, and/or other content as desired. Some or all of this information may be shared with other users, as desired.

An example retailer profile may include, but not be limited to, company information, company history, listing of products, product details, market availability, locations, contact information, and other content as desired. Some or all of this information may be shared with other users, as desired.

The user(s) above may elect to share some or all of its information with other users. A potential benefit to this systems and methods may be that users realize additional value as a result of this exchange.

This may include, but not be limited to, a user sharing certain personal information to a brand manufacturer and receiving a discount on a product(s) or an increase in an existing discount on selected product(s). A potential benefit to the manufacturer may be to gain a better understanding of its consumer base, who they are, what they desire, and/or how to improve its business, better motivate and connect with its consumers, and/or provide more efficient offers. An example of this may be, but not limited to, a consumer desires to collect an offer from Brand A that includes a discount amount of $1.00 when purchasing two (2) products. The consumer is then presented with an offer from Brand A that increases the offer to $1.50 if consumer provides household income information. In this method, the consumer was able to increase his or her discount amount by providing requested information.

Another potential benefit may be the ability to present end user agreement(s) that detail terms and conditions pertaining to the acceptance and use of the coupons/offers which may reduce or eliminate the need to display the same on the individual coupons and may allow for more/other promotional information to be displayed.

This information and value exchange may progress from time to time between users of the systems and methods in an effort to further improve the efficiencies of current and future promotions and communications between users. These exchanges may result in the ability for manufacturers to create more efficient coupon offers for users and/or user groups based on insights gained through this information exchange.

Personalization of Coupons

According to other aspects of example implementations of the present disclosure, systems and methods are provided herein for a manufacturer to personalize certain coupons (FIG. 10) to the intended consumer by adding certain identifying information to the coupon which may be visible when displayed or printed. Such personalization may include, but not be limited to: consumer name, location, shopper card number, bar code/coupon code, contact info, and/or IP/MAC address. By way of example, but not to limit, this could be a statement printed on the coupon that reads, “this coupon is presented to, Jane Doe by Manufacturer A” (34). One potential benefit of such personalization is the consumer feeling more endeared to the manufacturer and therefore increasing the likelihood of redeeming the coupon and buying product. Another potential benefit of such personalization is the ability to remove some of the anonymity of coupon usage and in turn may prevent fraud through unauthorized duplication. With such personalization capabilities, coupled with the unique identifier on each coupon, the manufacturer may be inclined to offer coupons with higher values with less perceived risk of potential fraudulent use. Manufacturers may find other benefits and use of coupons exhibiting such features, such as, but not limited to, rewards and/or as make-goods to rectify a complaint. To provide further explanation of how this systems and methods may be used by manufacturers as a means by which to satisfy a consumer's complaint involving the purchase and/or use of a product. The following could be an example of such use, but not limited to, wherein a consumer contacts a manufacturer about the dissatisfaction of one of its products after purchase and the manufacturer responds with a personalized and highly valuable coupon created and provided through the systems and methods as a means of compensation and/or reimbursement to the consumer. Another example of such use could include, but not be limited to, the use of coupons for products which are age restricted such as alcohol, tobacco, and some medications.

Set Final Price Amounts versus Discounted Amounts

According to other aspects of example implementations of the present disclosure, systems and methods are provided herein for a manufacturer to elect to provide a coupon that offers the product at a final price paid versus a discounted amount off a retailer's price (FIG. 11). Current coupons state a discount amount to be realized by the purchaser at the time of purchase when purchasing qualifying products, and as such, a consumer is made aware of the discounted amount, but may not have information into the final price he or she will pay for the item at the time and location of purchase. A consumer may find it necessary and/or desirable to spend time researching current retail prices at participating retailers so that he or she may compute the final price in which he or she will pay for the product(s) after redeeming the coupon. An example of this may be where a consumer receives a coupon for a $1.00 off Brand A when he or she purchases one (1) qualifying product. The consumer then may research prices displayed for the qualifying products at Retailer I and Retailer 2 and make a determination of where to redeem the coupon after considering prices and other attributes of each retailer. Some consumers may find this process lengthy and complex, whereas in this example implementation the coupon clearly states a final price paid by the consumer at the point of sale at any participating retailer. For example, Brand A may offer a coupon that states a final price of $.01 (35) when qualifying products are purchased at any participating retailer regardless of the retailer's price offered at that location. An example scenario could be a user of the systems and methods collects an offer that states: “Buy any Brand A item that is 12 ounces or larger at any participating retailer and only pay $.05 for that item.” In this example implementation, a potential benefit to the consumer is that he or she is immediately made aware of the final price he or she will pay when purchasing the item regardless of the retailer's displayed price. A potential benefit to the manufacturer may be that it can create offers that may be more enticing to consumers and influence its consumers to make a purchase of its products.

Consumer and Manufacturer Making Future Commitments to the Other

According to other aspects of example implementations of the present disclosure, systems and methods the manufacturer may decide to offer coupons to certain and/or qualifying consumers in which the consumer makes a commitment to the manufacturer (FIG. 12) to make a certain number of future purchases over the course of a set time period and/or across multiple transactions and/or across multiple retail locations. In such, a consumer and manufacturer are coming together to agree upon each party providing to the other, an exchange of value in the future, based upon each one performing at certain levels and/or at or within certain time periods. In such an arrangement, a consumer and manufacturer have full knowledge and/or intent of the other in respect to future activities relating to the arrangement. A manufacturer may commit to providing a certain consumer with a series of offers, which may include, by way of example, but not limited to coupons, recipes, cookbooks, product information, nutrition, branded products, and/or promotional products in exchange for the consumer to commit to making future purchases of certain products/services, during a period of time and/or at certain intervals. An example of this may be, but not limited to, a consumer and manufacturer agree that if consumer purchases ten (10) products over the next twelve (12) months (which could be through multiple retail locations and/or through multiple transactions), then the manufacturer will provide a coupon(s) to be used during each shopping trip and/or a one-time reward after all purchase commitments are made and verified. In an example such as this, a manufacturer may provide a series of coupons, which may progress in value over time, to be used by the consumer during each qualifying transaction. An example of such an offer may include, but not be limited to, a consumer agrees to purchase 10 products over the next 12 months and in exchange, the manufacturer agrees to provide the consumer with 10 coupons, at the appropriate time based upon prior purchase activity and/or agreed upon intervals. Those 10 coupons may each have a value of $1 off the purchase of one (I) item and each coupon would be valid for a different period of time. Once all 10 purchase commitments have been made by the consumer, the manufacturer provides the final agreed upon offer (which may include free or highly discounted products) as a reward to that consumer (45). Another example may be that the consumer receives offers that are progressively better than the next as certain purchase requirements are completed (FIGS. 12A-12D). In such an example, a manufacturer may provide 10 coupons, each with varying value amounts to be used in progression. This may include an example, but not be limited to, wherein a first coupon is good for $1 off the purchase of one (1) product when used within the next 30 days, the second coupon may be good for $1.25 off the purchase of one (1) product when used between the 31^{st} and 60^{th} day, the third coupon may be good for $1.50 off the purchase of one (1) product when used between the 61^{st} day and the 90^{th} day, and so on. The validity of such coupons may or may not each have limitations of use such as, each coupon is only valid for use after the previous coupon has been used within the time period. These coupons may be delivered to the consumer all at once and/or delivered at certain intervals of time and/or upon verification of previous offers being redeemed and/or purchase commitments being fulfilled. In certain current systems, manufacturers may provide an offer to a consumer based upon the redemption of a previous offer(s); however, these systems do not include a pre-arranged agreement between the manufacturer and consumer and therefore may not provide certain benefits of the systems and methods. One benefit of the systems and methods may be when the consumer and manufacturer enter into an agreement together, one or both may feel more emotionally connected to the other and such a connection may provide some increased level of value provided by one to the other. Another benefit may be that when the consumer and manufacturer both understand and have visibility into the future promised activities of the other, they may in turn provide more value to the other. The consumer may make more purchases of the manufacturer's product over a period of time, either because of increased use and/or the planned purchase of that manufacturer's product over its competitor product and thus increasing product sales for the manufacturer, and/or through these incremental sale(s), wherein the manufacturer may have the ability to pass on more offers and/or increased discounts to the consumer through a more efficient promotional and/or planning process. Another benefit may be that the consumer, with full knowledge of the availability of future offers (which may be predicated upon making certain purchases in the shorter term) may increase his or her purchases, in which increases sales for the manufacturer.

Manufacturers and Retailers Dynamic Offer Creation; “Bidding”

According to other aspects of example implementations of the present disclosure, systems and methods provide the manufacturer and retailer to enter savings amounts as offers to a consumer or groups of consumers that compete with competitive offers presented by its competitors. For example a manufacturer may determine that its products compete directly with another manufacturer's products and therefore both companies compete for the same consumer. The manufacturer may enter a value that adds to the amount that another competitor offers to the same consumer group. If Manufacturer A offers $.50 and Manufacturer B wants to offer an amount greater than $.50 then, based on the predetermined set of parameters entered, the systems and methods creates an offer that adds, for example, $.25 to the $.50 that Manufacturer A offers. It can also enter a maximum value range that provides the consumer with a value that looks up and returns that value or a value that is lower, but still the highest amount available to the consumer. For example, Manufacturer A enters a max value of $.50, but its closest competitor is the next highest bidder at $.40, the system will return a value of $.45 or the amount equal to the agreed upon increment or the additional amount. In such an example, the manufacturer may enter minimum values, maximum values, and desired increments in which it sets to provide the systems and methods with the parameters of creating offers dynamically based on the competitive offers in the system. Thus the manufacturer creates offer value parameters that allow the systems and methods to automatically produce offers that are competitive based on the other offers in the market. Another example may be, but not limited to, Manufacturer B desires to always have the highest value offer for particular product(s) for a period of time, as such Manufacturer B enters a minimum offer value of $.50; a maximum offer value of $2.00; and an increment of $.25. When a consumer requests an offer for a similar and/or competitive product from Manufacturer C, the systems and methods retrieves the offer available on such product. In this case, the offer available is $.75 off Manufacturer C. The systems and methods will also return a competitive offer from Manufacturer B of $1.00 off ($.75+$.25=$1.00) for the consumer to view and potentially choose. In such a case, Manufacturer B may be able to entice a consumer to try its product(s) with a more compelling offer than returned for Manufacturer C. The systems and methods will be able to create a number of offer combinations based on the parameters entered into the Manufacturer's Database (23). Furthermore, manufacturers may find benefit in the systems and methods through the ability to set offer parameters and create coupons/offers that are competitive in the current market environment yet not over or under competitive and thus creating more efficient promotional channel and marketing expenditures.

Manufacturers may also, through the systems and methods, find it beneficial to set maximum budget amounts in the systems and methods wherein a manufacturer can limit its expenditures by, for example, but without limitation, campaign, offer, product, product group, product category, distribution channel, retailer, and/or time period. Offers are created by the systems and methods based on the set parameters until such budget limits are reached and at that point, the systems and methods may return no further offers to the consumer from the manufacturer.

Retailers may also find the examples described above beneficial to its business and may use the same to compete in markets with its competitors by creating similar offers for its products/services and/or utilize the bidding method described above to add value to manufacturer offers in the same manner as above. For example, but not to limit, Retailer A may set a minimum value of $.25, a maximum value of $1.00, and an increment of $.50. As such, when a Manufacturer's Coupon is presented, Retailer B may present an additional $.50 to entice a consumer to use the coupon at its locations. The systems and methods will also return an offer from Retailer A of $1.00 ($.50+$.50). In this case, Retailer A was able to offer the consumer an offer that was more competitive than Retailer B by using the systems and methods in such a manner. Retailers may find similar benefit as stated above as related to manufacturers.

A potential benefit of the systems and methods for manufacturers and retailers may be the ability to create offers based on current and/or competitive offers in the marketplace, budgetary guidelines, product demands, inventory levels, product expiration dates, sales objectives, new product launches, and/or consumer demand, to name a few, but without limitation.

Event Triggered Coupons

According to other aspects of example implementations of the present disclosure, systems and methods include the ability for manufacturers and/or retailers to pre-set parameters relating to events that when they occur and exceed such parameters, the systems and methods may trigger a pre-set coupon or series of coupons (FIG. 13). By way of example, such events could include but not be limited to, inventory levels, product dating, weather conditions, and/or market conditions (46). As an example of creating offers based on inventory levels could be that as manufacturers and/or retailers monitor current inventory levels to improve GMROII (Gross Margin Return on Inventory Investment), they may use the systems and methods to create, distribute, promote, and/or offer coupons to consumers when such inventory levels fall outside of set parameters. For example, if inventory levels of a certain product are high, the systems and methods may create an aggressive offer and distribute it to consumers in an effort to create consumer demand for the product and move inventory in a short amount of time. Furthermore, the systems and methods may stop or reduce the availability and/or the promotion of certain coupons to reduce the amount of consumer demand and thus reduce the potential for an out-of-stock situation.

Systems and Methods Revenue Stream Models

According to other aspects of example implementations of the present disclosure, systems and methods provide the ability for manufacturers and/or retailers to pay for the use of the systems and methods on a per coupon/offer redeemed/used basis. The systems and methods will calculate the fee(s) per coupon redeemed (used by the consumer) based on the then current pricing structure. For example, a manufacturer (coupon issuer) sets up a coupon in the systems and methods and, based on the current published rates, the systems and methods returns the amount that will be charged by the systems and methods each time the coupon/offer is used and validated at a participating retailer. For example, Manufacturer A sets up a coupon for $1 off the purchase of 2 products. Based on the values/elements of the coupon, the systems and methods may return a price (fee) of $.50 per coupon redeemed and validated though the systems and methods and payable to the systems and methods. The pricing structure for each coupon redeemed may vary and be based on the specifics of the coupon. The pricing structure may allow for volume pricing, flat rates, percentage of value, and/or other considerations from time to time. Further examples of such may be, but not limited to, charging a flat-fee and/or a percentage of the face value, charging a flat-fee per product purchased during redemption, and/or charging a percentage of the face value per product purchased during redemption.

The systems and methods may also be offered as a software license and paid for on a one-time and/or an ongoing periodic, e.g., annual, basis. Such a license may be structured and priced in a manner that provides for volume discounts, unlimited redemptions, and/or tiered pricing based on the number of concurrent coupons/offers loaded. The potential benefits of such a pricing methodology to the manufacturer may be the ability to better estimate and project costs of each promotion. Furthermore, manufacturers/retailers may find that by paying a flat-fee and/or a fee only when a coupon is redeemed is more cost effective than other models wherein fees are charged based on distribution versus redemption/use, as described herein. The systems and methods may also provide pricing models that allow manufacturers/retailers to bid on the prominent display of their coupons/offers to certain consumers. Such bidding may allow manufacturers to compete for the display of an advertisement and/or coupon/offer to certain consumers. Such a model may provide for the current highest bidder to be displayed exclusively and/or displayed in a better/more prominent location.

As an additional benefit, the systems and methods may also total other charges, as agreed to between the manufacturer and retailer(s) as a means of providing a more complete projection of costs/fees which may be incurred during the promotion.

Display and Communication of Offer Limitations

According to other aspects of example implementations of the present disclosure, systems and methods provide the consumer with an updated quantity of the remaining total available for each specific coupon (FIG. 14). Manufacturers may find it beneficial to display the total number of coupons available (52) to qualified consumers when a certain offer may be in limited quantities and this notification may entice consumers to collect the coupon quicker and/or redeem the offer at participating retailer(s) in a lesser amount of time. As consumers receive such coupons the user interface updates and reduces the quantity available (on hand) until exhausted. Consumers may find it beneficial to be informed of such a limited quantity, so that he or she may respond accordingly and in a manner that allows him or her to use the coupon within the limitations and time restrictions. Certain reminders may be sent or available periodically to the consumer that updates him or her on the remaining time limitations of which to utilize the coupon. A potential benefit of such may be that the manufacturer has the ability to entice the consumer to collect and/or utilize the coupon quicker and within the timeframe and may also have the ability to disallow consumers to utilize the offer after such time has passed even though a coupon may already have been collected by, stored by, and or in the possession of the consumer. In a typical paper coupon system, the consumer is essentially guaranteed the redemption/use of such when presented at a participating retailer and in accordance with the policies and within the expiration date printed. The systems and methods described herein provide the ability for the manufacturer to limit the validity/use of such a coupon once the total number of allowable redemptions/uses have taken place. After such limits have been reached, the systems and methods may decline further redemptions of such coupons by consumers. Another potential benefit of the systems and methods may be the ability for the manufacturer (coupon issuer) to contain the redemption/use of the coupon and stay within the budgetary limits of the promotion. For example, a manufacturer may present a coupon through the systems and methods with the displayed limit of, for example, 10,000 allowable redemptions/uses, wherein only the first 10,000 coupons presented will be validated and/or honored. In such an example, the coupon expiration/validity is not necessarily only limited by an expiration date displayed on the coupon, but is further limited by the market response.

Pre-Set Maximum of Redeemable Coupons

According to other aspects of example implementations of the present disclosure, systems and methods are provided herein where the manufacturer has the option of creating limitations on the number of coupons available for use in the market during the promotional period. Manufacturers may find it beneficial to have the option of setting a limit to the number of coupons that may be collected and/or redeemed at participating retailers by consumers who have collected the coupon. By setting collection and/or redemption limits for certain coupons, manufacturers may find the promotional budgeting process more accurate and at the same time create an engaging, yet competitive environment for its consumers.

Additionally, consumers may find this system rewarding for those exerting additional efforts to ensure compliance with the coupon's limitations over their peers. As way of example, but not to limit, a manufacturer may create an offer in the system that allows a total of, for example, 10,000 coupons to be redeemed at participating retailers within the promotional period. The redemption validity and/or availability of such a coupon will be subject to the limit of 10,000 units regardless of the stated expiration date on each coupon or the fact that a consumer may have a coupon in his or her possession. In some cases, to avoid confusion and frustration by the consumer, the manufacturer may also offer a grace period for certain consumers to redeem the coupons currently in their possession regardless of redemption limits being reached during the grace period, as an example of a possible iteration. This may also allow the systems time to receive and process information throughout the system and provide updated information and enforce set limitations.

Communication Interface between Multiple Independent Manufacturers within a Single Consumer Interface

According to other aspects of example implementations of the present disclosure, systems and methods are provided herein include an interface allowing consumers to select certain manufacturers in which to have potentially more personal interactions through the mutual exchange of information in which a consumer may not be inclined to other manufacturers in other settings. Such information exchange could include, by way of example and without limitation:
1. The consumer providing private and/or public product reviews;
2. The consumer providing suggested new products for development;
3. The consumer suggesting changes to existing products;
4. The consumer providing his or her reasons for choosing the manufacturer's product(s) over other similar and/or competing products;
5. The manufacturer providing details of ingredients, formulas, recipes, and/or nutrition of the product(s) that may or may not be available elsewhere;
6. The manufacturer providing usage tips, serving sizes and portions specific to the consumer's use;
7. The manufacturer providing notification of upcoming new product launches and/or availability; and/or
8. The manufacturer providing updated recall information, warnings, potential hazards, and/or other information in a potentially quicker manner than otherwise available.

The interface allows for such information exchange to take place through multiple points of access and through a plurality of devices, including but not limited to: computers, mobile devices, and/or phones, in which the information may be duplicative, independent, synchronized, personalized, and/or customized in other ways by the consumer and/or manufacturer.

A potential benefit of such an interface, in addition to the value created within the exchange of information, may be the analysis of certain information in a manner that allows for aggregation, filtering, plotting, and/or tracking of consumers and/or manufacturers. Such analysis may indicate trends, opportunities, positive and/or negative attitudes, and/or other useful information from time to time.

Interface for the Creation of Retailer-Specific Coupons

According to other aspects of example implementations of the present disclosure, systems and methods a manufacturer (or its proxy) can, in a self-service manner, create, customize and/or designate certain coupons to be valid only at a certain retailer(s) and whereby the unique identifier and/or bar code is further customized to be only recognized by and redeemed at the stated retailer. As such, the coupon will be then considered a “Store Coupon” instead of a “Manufacturer's Coupon”. The interface allows the manufacturer to create multiple coupons in a myriad of configurations and under predetermined guidelines preapproved by the respective retailers. In such, a manufacturer and/or retailer may include incentives for the other to entice the other for creating and/or accepting such coupons. Both parties may also pool available resources and incentives and give to the other or present those to an interested consumer.

Examples of such incentives offered by the retailer to the manufacturer may include, but not be limited to: a discount or abolishment of certain fees typically charged on the acceptance of similar coupons, such as coupon processing fees, handling fees, incremental sales floor space fees, advertising fees, and/or other valuable considerations. Examples of such incentives offered by the manufacturer to the retailer may include, but not be limited to: a higher value coupon; an exclusive product offering for the retailer, advertising; and/or other valuable considerations that the retailer may find enticing.

A potential benefit of the systems and methods to the manufacturer may be that having access to a single interface in which multiple independent retailers are participating provides an easy method of creating Store Coupons that can be approved by such a retailer in a faster manner resulting in a more efficient promotional expenditure. Another potential benefit of the systems and methods to the manufacturer may be the ability to create and distribute multiple coupons of varying criteria across multiple independent retailers that integrates in each respective retailer's point-of-sale system, store coupon system, shopper/loyalty card system, web-site, mobile application(s), and/or other internal, external, or consumer-facing interfaces that facilitate the transference, storage, distribution, and/or redemption of the coupon.

A benefit of the systems and methods to the retailer may be an increase in number and/or value of Manufacturer's Coupons created for or customized to its locations. Such an increase could be seen as an additional benefit by its customers and therefore provide a competitive advantage in the marketplace and/or increase sales. Participating retailers may also find the systems and methods to reduce time and expense and provide a more efficient channel for such promotions and may, in turn pass some or all of those savings to the manufacturer and/or consumer in an effort to increase available offers or entice consumers to shop at its locations.

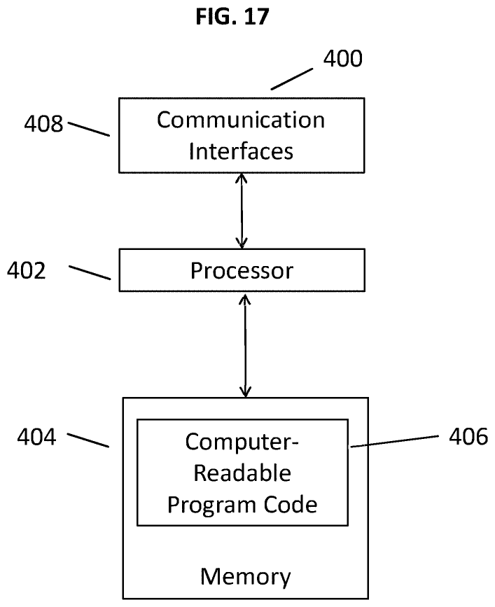

It is also to be understood that computer 400 (FIG. 17) is used with implementations of the systems and methods for users to create, customize, and/or select coupons in accordance with the present disclosure. More specifically, computer system 400 could draw information from and receive inputs from other sources, and such sources could be remote and received through wire or wireless connection with the Internet or communications via other means including, but not limited to, microwave, radio frequency, Bluetooth, hardwire, electricity transmission lines, telephone, and/or other available communication modalities.

FIG. 17 illustrates control system 400 that, according to some example implementations of the systems and methods of the customization, collaboration, and validation of coupons in accordance with the present disclosure, may be configured to at least partially implement the operation of such systems and methods. Generally, the apparatus of exemplary implementations of the systems of the present disclosure may comprise, include or be embodied in one or more fixed, portable or embedded electronic devices. The apparatus may include one or more of each of a number of components such as, for example, a processor 402 comprising hardware and software connected to a memory 404 for the databases discussed herein. For each sensor, processor 402 may receive a measurement and/or data from the sensor.

The processor 402 is generally any piece or component of computer hardware that is capable of processing information such as, for example, data, computer-readable program code, instructions or the like (at times generally referred to as “computer programs,” e.g., software, firmware, etc.), and/or other suitable electronic information. The processor is composed of a collection of electronic circuits some of which may be packaged as an integrated circuit or multiple interconnected integrated circuits (an integrated circuit at times more commonly referred to as a “chip”). The processor may be configured to execute computer programs, which may be stored onboard the processor or otherwise stored in the memory 404 (of the same or another apparatus).

The processor 402 may be a number of processors, a multi-processor core or some other type of processor, depending on the particular implementation. Further, the processor may be implemented using a number of heterogeneous processor systems in which a main processor is present with one or more secondary processors on a single chip. As another illustrative example, the processor may be a symmetric multi-processor system containing multiple processors of the same type. In yet another example, the processor may be embodied as or otherwise include one or more application-specific integrated circuits (ASICs), field-programmable gate arrays (FPGAs) or the like. Thus, although the processor may be capable of executing a computer program to perform one or more functions, the processor of various examples may be capable of performing one or more functions without the aid of a computer program.

The memory 404 is generally any piece or component of computer hardware that is capable of storing information such as, for example, data, computer programs (e.g., computer-readable program code 406) and/or other suitable information either on a temporary basis and/or a permanent basis. The memory may include volatile and/or non-volatile memory, and may be fixed or removable. Examples of suitable memory include random access memory (RAM), read-only memory (ROM), a hard drive, a flash memory, a thumb drive, a removable computer diskette, an optical disk, a magnetic tape or some combination of the above. Optical disks may include compact disc-read only memory (CD-ROM), compact disc-read/write (CD-R/W), digital versatile disc (DVD) or other standard media and format. In various instances, the memory may be referred to as a computer-readable storage medium which, as a non-transitory device capable of storing information, may be distinguishable from computer-readable transmission media such as electronic transitory signals capable of carrying information from one location to another. Computer-readable medium as described herein may generally refer to a computer-readable storage medium or computer-readable transmission medium.

In addition to the memory 404, the processor 402 may also be connected to one or more of the communication interfaces 408 for displaying, transmitting and/or receiving information. The communications interface may be configured to transmit and/or receive information, such as to and/or from other apparatus(es), network(s) or the like. The communications interface may be configured to transmit and/or receive information by physical (wireline) and/or wireless communications links. Examples of suitable communication interfaces include a network interface controller (NIC), wireless NIC (WNIC) or the like.

As indicated above, program code instructions may be stored in memory, and executed by a processor, to implement functions of the systems, subsystems and their respective elements described herein. As may be appreciated, any suitable program code instructions may be loaded onto a computer comprising hardware and software, or other programmable apparatus from a computer-readable storage medium to produce a particular machine, such that the particular machine becomes a means for implementing the functions specified herein. These program code instructions may also be stored in a computer-readable storage medium that can direct a computer, a processor or other programmable apparatus to function in a particular manner to thereby generate a particular machine or particular article of manufacture. The instructions stored in the computer-readable storage medium may produce an article of manufacture, where the article of manufacture becomes a means for implementing functions described herein. The program code instructions may be retrieved from a computer-readable storage medium and loaded into a computer, processor or other programmable apparatus to configure the computer, processor or other programmable apparatus to execute operations to be performed on or by the computer, processor or other programmable apparatus. Retrieval, loading and execution of the program code instructions may be performed sequentially such that one instruction is retrieved, loaded and executed at a time. In some example implementations, retrieval, loading and/or execution may be performed in parallel such that multiple instructions are retrieved, loaded, and/or executed together. Execution of the program code instructions may produce a computer-implemented process such that the instructions executed by the computer, processor or other programmable apparatus provide operations for implementing functions described herein.

Execution of instructions by a processor, or storage of instructions in a computer-readable storage medium, supports combinations of operations for performing the specified functions. In this manner, an apparatus 400 may include a processor 402 and a computer-readable storage medium or memory 404 coupled to the processor, where the processor is configured to execute computer-readable program code 406 stored in the memory. It will also be understood that one or more functions, and combinations of functions, may be implemented by special purpose hardware-based computer systems and/or processors which perform the specified functions, or combinations of special purpose hardware and program code instructions.

Different examples of the systems and methods disclosed herein include a variety of components, features, and functionalities. It should be understood that the various examples of the systems and methods disclosed herein may include any of the components, features, and functionalities of any of the other examples of systems and methods disclosed herein in any combination, and all of such possibilities are intended to be within the spirit and scope of the present disclosure.

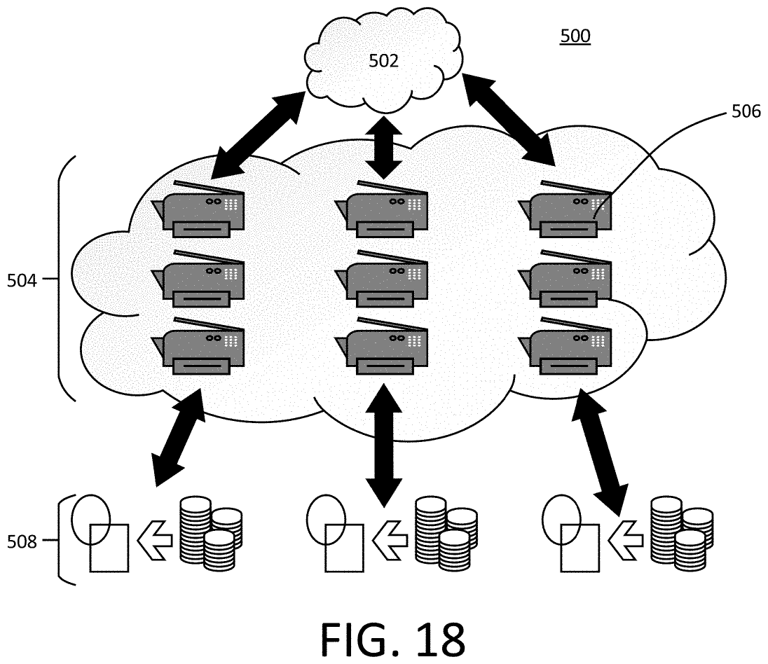

Referring to FIG. 18, an edge computing system 500 is illustratively depicted, in accordance with various embodiments of the present disclosure.

According to various embodiments, computer system 400 can function with, or act as a component of (e.g., node 506) edge computing system 500.

According to various embodiments, the edge computing system 500 includes one or more point-of-sale points 508 (e.g., a cash register and/or other suitable point-of-sale points) and one or more edge nodes 506, within an edge layer 504, centrally connected to the cloud 502. One or more of the connections between any of the components of the edge computing system 500 can be wired, wireless, and/or a combination of wired and wireless. Each node 506 can also include one or more of a processor (e.g., processor 402) and a memory (e.g., memory 404).

According to various embodiments, one or more of the nodes 506 can be placed near one or more retailer point-of-sale points 508. A series of nodes 506 is placed near certain retailer point-of-sale points 508, with the result that the work performed by each node 506 is performed faster than if the same amount of work were to be performed by one centralized location in the cloud 502. This system of hardware and software enables the time needed for processing the transaction data to be decreased while removing and/or decreasing network lag times.

The more time that is needed in order for a computing system to complete the required tasks, the longer each sale takes to complete, thereby decreasing the number of possible sales that can be completed in a given timeframe and potentially delaying a customer and/or causing customer frustration, which can also lead to decreased customer satisfaction and sales. Accordingly, it is desirable to reduce or eliminate lag times in order to increase checkout time efficiency for the customer.

Detrimental issues with cloud computing alone include computer processing delays, causing inefficiencies, downstream delays and/or increased customer wait times. Processing data from thousands of retailer point-of-sale systems without impacting customer wait times can be a large task and can require software that can route traffic during peak times, perform the necessary computer processing, and return the data quickly and efficiently. The speed at which the data would need to be processed and returned is preferably within a fraction of a second. Retailer transaction times should not be delayed by this process, as the customer wait time would correspondingly be lengthened.

In previous systems, retailers that used 3rd party systems to process transactional data required a physical server in every store location that could only process data based on rules that were preloaded and updated perhaps only once per day, or weekly. This can make launching or changing programs in real-time particularly difficult or not feasible.

In order to correct for this issue, using the edge computer system 500 (as shown, e.g., in FIG. 18) allows nearby nodes to be updated, as needed, anytime, and in real-time. Given the potential amount of data transferred, and the speed at which such data must be processed, scalable servers, robust software, and a network of computing nodes 506 permit this process to work, whereby transactional data can be sent in real-time to these nodes 506 on the edge layer 504, and be processed quickly and returned, thus improving upon the data processing speed of existing technologies and systems and being more efficient than existing technologies.

According to various embodiments, each computing node 506 is in electronic communication with one or more of the point-of-sale points/devices 508. According to various embodiments, the greater the number of nodes 506 available for each point-of-sale device 508, the less the computing power and/or energy consumption needed for each processor of the one or more computing nodes 506 to execute the one or more programming instructions in the memory. According to various embodiments, the computing nodes 506 are configured such that an increase in a number of computing nodes 506 decreases an overall timeframe needed to execute the one or more programming instructions.

According to various embodiments, the workload of the computer system, using an edge computing structure (such as, e.g., shown in FIG. 18) allows for parallel processing of data and also allows for the spread of the workload of the computer system 500 across the plurality of nodes 506, decreasing computing time due to each node 506 only handling local traffic, which, in turn, causes less data to be used or processed. By the nodes 506 being connected closer to the point-of-sale location 508 than a centralized location in the cloud 502, latency is further reduced, since data traffic is potentially traveling through less physical distance and/or through a reduced number of individual networks, relays, switches, etc. than would be the case using cloud 502 alone. With a network having a centralized location in the cloud 502, all (or near all) traffic is potentially being routed to one central stack in the cloud 502, and potentially requiring larger servers scaling up and/or down, based on the amount of data traffic, resulting in the data traffic having to travel through more obstacles, thereby slowing data speeds. In contrast, with edge computing, the edge layer 504 of the system 500 could be proximate to and connected with the point-of-sale systems 508.

Many modifications and other implementations of the disclosure set forth herein will come to mind to one skilled in the art to which these disclosures pertain having the benefit of the teachings presented in the foregoing descriptions and the associated drawings. Therefore, it is to be understood that the disclosure are not to be limited to the specific implementations disclosed and that modifications and other implementations are intended to be included within the scope of this disclosure.

Moreover, although the foregoing descriptions and the associated drawings describe example implementations in the context of certain example combinations of elements and/or functions, it should be appreciated that different combinations of elements and/or functions may be provided by alternative implementations without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

1. A system for generating and implementing one or more promotional offers for goods and/or services, comprising:
a communications interface configured to enable retailers, manufacturers, and consumers to collaborate, via a wired or wireless network, to determine one or more parameters pertaining to each of one or more promotional offers;
one or more computing nodes in electronic communication with one or more point-of-sale devices, each edge node including:
a processor; and
a computer-readable storage medium comprising one or more programming instructions that, when executed, cause the processor to:
generate a unique master coupon code, wherein the unique master coupon code is linked to the one or more promotional offers;
read the unique master coupon code at a first location, generating a list of the one or more promotional offers linked to the unique master coupon code,
wherein reading the unique master coupon code includes validating the unique master coupon code by:
cross-referencing, via the communications interface, the unique master coupon code with one or more coupon codes stored at a second location; and
sending an indication of validity to the first location;
determine, for each of the one or more promotional offers, whether the one or more parameters have been met; and
redeem each promotional offer for which the one or more parameters have been met.

2. The system of claim 1, further comprising at least one point-of-sale device.

3. The system of claim 2, wherein:
the at least one point-of-sale device includes a plurality of point-of-sale devices, and
each point-of-sale device in the plurality of point-of-sale devices is in electronic communication with a unique computing node of the one or more computing nodes, thereby decreasing computing power needed for each processor of the one or more computing nodes to execute the one or more programming instructions.

4. The system of claim 1, wherein the one or more computing nodes are configured such that an increase in a number of computing nodes decreases an overall timeframe needed to execute the one or more programming instructions.

5. The system of claim 1, wherein the one or more parameters pertain to one or more of the following:
creation of the one or more promotional offers;
alteration of the one or more promotional offers;
distribution of the one or more promotional offers;
redemption of the one or more promotional offers; and
payment terms for the one or more promotional offers.

6. A method for generating and implementing one or more promotional offers for goods and/or services, comprising:
determining, via a communications interface, one or more parameters pertaining to each of one or more promotional offers,
wherein the communications interface is configured to enable retailers, manufacturers, and consumers to collaborate, via a wired or wireless network; and
using at least one computing node, each computing node including a processor and a computer-readable storage medium, wherein:
each computing node is in electronic communication with one or more point-of-sale devices, and
the computer-readable storage medium comprising one or more programming instructions that, when executed, cause the processor to:
generate a unique master coupon code, wherein the unique master coupon code is linked to the one or more promotional offers;
read the unique master coupon code, generating a list of the one or more promotional offers linked to the unique master coupon code;
determine, for each of the one or more promotional offers, whether the one or more parameters have been met; and
redeem each promotional offer for which the one or more parameters have been met.

7. The method of claim 6, wherein the one or more parameters pertain to one or more of the following:
creation of the one or more promotional offers;
alteration of the one or more promotional offers;
distribution of the one or more promotional offers;
redemption of the one or more promotional offers; and
payment terms for the one or more promotional offers.

8. The method of claim 6, wherein each point-of-sale device is in electronic communication with a unique computing node of the one or more computing nodes, thereby decreasing computing power needed for each processor of the one or more computing nodes to execute the one or more programming instructions.

9. The method of claim 6, wherein the one or more computing nodes are configured such that an increase in a number of computing nodes decreases an overall timeframe needed to execute the one or more programming instructions.
